(19) United States
(12) Patent Application Publication
(10) Pub. No.: US 2024/0200594 A1
(43) Pub. Date: Jun. 20, 2024

(54) WHEEL HUB ASSEMBLIES, WHEEL ASSEMBLIES AND RELATED METHODS

(71) Applicant: REE AUTOMOTIVE LTD, Glil-Yam (IL)

(72) Inventors: Amnon SHKEDY, Tel-Aviv (IL); Ido GURY, Tel-Aviv Jaffa (IL)

(73) Assignee: REE AUTOMOTIVE LTD, Glil-Yam (IL)

(21) Appl. No.: 18/530,430

(22) Filed: Dec. 6, 2023

Related U.S. Application Data
(60) Provisional application No. 63/432,513, filed on Dec. 14, 2022.

(51) Int. Cl. F16C 19/54; B62D 7/18

(52) U.S. Cl. CPC F16C 19/548; B62D 7/18; F16C 2326/02

(57) ABSTRACT

A wheel hub assembly couplable to an upright including an axial hub cavity having a cavity opening at an outer end of the upright, the wheel hub assembly may include: a hub extending axially along a rotation axis, the hub comprising a bore extending axially along the rotation axis; a hub shaft extending through the bore of the hub; one or more bearing assemblies, each bearing assembly including an annular housing surrounding at least a portion of the hub; and a fastening assembly to affix the hub and the hub shaft together; wherein the hub shaft, the hub and the one or more bearing assemblies are removably insertable into the hub cavity and assemblable within the hub cavity through the cavity opening.

### CROSS REFERENCE TO RELATED APPLICATIONS

This application claims priority to U.S. Provisional Application No. 63/432,513 filed on Dec. 14, 2022, which is hereby incorporated by reference in its entirety.

### FIELD OF THE INVENTION

The present invention relates to the field of axle assemblies, and more particularly, to wheel hub assemblies.

### BACKGROUND OF THE INVENTION

A common wheel hub assembly can include a hub to which a wheel can be assembled, and a plurality of bearing members embedded within the hub to support rotation of the hub with respect to an upright when the hub is assembled thereon. Typically, in order to assemble the hub to the upright, the hub needs to be accessed from both inner end of the upright (facing a frame of a vehicle) and outer end of the upright. However, accessing the inner end of the upright may be complex and, in some cases, impossible. The bearing members of common wheel hub assembly are typically embedded within the hub assembly and cannot be replaced. In the case of malfunction and/or adjustment requirement of the bearing members, the hub and/or the entire wheel hub assembly needs to be replaced.

### SUMMARY OF THE INVENTION

Embodiments of the present invention may provide a wheel hub assembly couplable to an upright which may include an axial hub cavity having a cavity opening at an outer end of the upright, the wheel hub assembly may include: a hub extending axially along a rotation axis, the hub includes a bore extending axially along the rotation axis; a hub shaft extending through the bore of the hub; one or more bearing assemblies, each bearing assembly includes an annular housing surrounding at least a portion of the hub; and a fastening assembly to affix the hub and the hub shaft together; wherein the hub shaft, the hub and the one or more bearing assemblies are removably insertable into the hub cavity and assemblable within the hub cavity through the cavity opening.

In some embodiments, the hub shaft, the hub and the one or more bearing assemblies are removably insertable into the hub cavity, assemblable, and affixed within the hub cavity through the cavity opening.

In some embodiments, the one or more bearings assemblies is preloaded in an axial direction by the fastening assembly.

In some embodiments, the one or more bearing assemblies includes: a first bearing assembly and a second bearing assembly, the first bearing assembly being disposed within the hub cavity deeper than the second bearing assembly relative to the cavity opening.

In some embodiments, the wheel hub assembly includes a nut removably insertable into the hub cavity through the cavity opening, the nut being screwed into the hub cavity to hold the first bearing assembly and the hub shaft within the hub cavity.

In some embodiments, the fastening assembly includes a castle nut screwable onto the hub shaft to affix the hub to the hub shaft and to preload the first bearing assembly and the second bearing assembly in the axial direction.

In some embodiments, the nut applies, on an outer ring of the annular housing of the first bearing assembly, an axial force in a first axial direction, and the hub shaft applies, on an inner ring of the annular housing of the first bearing assembly an axial force in a second axial direction that is opposed to the first axial direction thereby preloading the first bearing assembly in an axial direction.

In some embodiments, the hub applies, on an inner ring of the annular housing of the second bearing assembly, an axial force in a first axial direction, and the nut applies, on an outer ring of the annular housing of the second bearing assembly, an axial force in a second axial direction that is opposed to the first axial direction thereby preloading the second bearing assembly in an axial direction.

In some embodiments, the wheel hub assembly includes a retaining ring removably insertable into the hub cavity through the cavity opening, the retaining ring being engageable with the hub cavity and the nut to prevent the nut from unintentionally unscrewing from within the hub cavity.

In some embodiments, the retaining ring includes a plurality of resilient members projecting from an annular portion of the retaining ring in the axial direction to apply the axial force on the outer ring of the annular housing of the second bearing assembly.

In some embodiments, the first bearing assembly and the second bearing assembly are tapered rolling bearings.

In some embodiments, the first bearing assembly and the second bearing assembly are tapered in opposite directions.

In some embodiments, the one or more bearing assemblies includes one bearing assembly.

In some embodiments, the bearing assembly is preloaded prior to assembling thereof within the cavity of the upright.

In some embodiments, the wheel hub assembly includes a nut removably insertable into the hub cavity through the cavity opening, the nut being screwed into the hub cavity to hold the bearing assembly and the hub shaft within the hub cavity.

In some embodiments, the hub shaft is a shaft configured to be powered by a motor.

Embodiments of the present invention may provide a wheel assembly which may include: an upright which may include: a cavity, an outer end includes an opening providing an access to the cavity, and an inner end that is opposed to the outer end; and a wheel hub assembly which may include: a hub extending from within the cavity of the upright external thereto, the hub includes a bore extending through a length of the hub; a hub shaft extending through the bore of the hub from within the cavity of the upright external thereto; one or more bearing assemblies, each bearing assembly includes an annular housing surrounding at least a part of a longitudinal portion of the hub; and a fastening assembly to affix the hub and the hub shaft together; wherein the hub shaft, the hub and the one or more bearing assemblies are removably insertable into the cavity and assemblable within the cavity of the upright through the opening on the outer end of the upright.

In some embodiments, the hub shaft, the hub and the one or more bearing assemblies are removably insertable into the cavity and assemblable within the cavity of the upright only through the opening on the outer end of the upright.

In some embodiments, the upright is configured to prevent an access to the cavity of the upright through the inner end of the upright.

In some embodiments, the inner end of the upright is a closed end.

In some embodiments, the upright includes a suspension coupler to couple the upright to a suspension, and wherein the suspension coupler and the opening of the cavity of the upright are disposed at opposing ends of the upright with respect to each other.

In some embodiments, the upright is steerable about a steering axis.

In some embodiments, the steering axis extends through the upright.

In some embodiments, the one or more bearing assemblies is preloaded in an axial direction by the fastening assembly.

In some embodiments, the one or more bearing assemblies includes: a first bearing assembly and a second bearing assembly, the first bearing assembly being disposed within the cavity of the upright deeper than the second bearing assembly relative to the opening on the outer end of the upright.

In some embodiments, the wheel hub assembly includes a nut removably insertable into the cavity through the opening on the outer end of the upright, the nut being screwed into the cavity to hold the first bearing assembly and the hub shaft within the cavity.

In some embodiments, the fastening assembly includes a castle nut screwable onto the hub shaft to affix the hub to the hub shaft and to preload the first bearing assembly and the second bearing assembly in an axial direction.

In some embodiments, the nut applies, on an outer ring of the annular housing of the first bearing assembly, an axial force in a first axial direction, and the hub shaft applies, on an inner ring of the annular housing of the first bearing assembly an axial force in a second axial direction that is opposed to the first axial direction thereby preloading the first bearing assembly in the axial direction.

In some embodiments, the hub applies, on an inner ring of the annular housing of the second bearing assembly, an axial force in a first axial direction, and the nut applies, on an outer ring of the annular housing of the second bearing assembly, an axial force in a second axial direction that is opposed to the first axial direction thereby preloading the second bearing assembly in the axial direction.

In some embodiments, the wheel hub assembly includes a retaining ring removably insertable into the cavity through the opening on the outer end of the upright, the retaining ring being engageable with the upright and the nut to prevent the nut from unintentionally unscrewing from within the cavity.

In some embodiments, the retaining ring includes a plurality of resilient members projecting from an annular portion of the retaining ring in the axial direction to apply the axial force on the outer ring of the annular housing of the second bearing assembly.

In some embodiments, the first bearing assembly and the second bearing assembly are tapered rolling bearings.

In some embodiments, the first bearing assembly and the second bearing assembly are tapered in opposite directions.

In some embodiments, the one or more bearing assemblies includes one bearing assembly.

In some embodiments, the bearing assembly is preloaded prior to assembling thereof within the cavity of the upright.

In some embodiments, the wheel hub assembly includes a nut removably insertable into the cavity through the opening on the outer end of the upright, the nut being screwed into the cavity to hold the bearing assembly and the hub shaft within the cavity.

In some embodiments, the hub shaft is at least a part of a shaft configured to be powered by a motor.

In some embodiments, the wheel assembly includes a wheel coupled to the hub of the wheel hub assembly.

In some embodiments, the wheel assembly includes a suspension arm to which the upright is coupled.

Embodiments of the present invention may provide a wheel corner assembly which may include: a sub-frame; and the wheel assembly described hereinabove and coupled to the sub-frame.

Embodiments of the present invention may provide a method of assembling a wheel hub assembly to an upright which may include an axial hub cavity having a cavity opening at an outer end of the upright, the method may include: through the cavity opening, inserting into the hub cavity and assembling therewith: a hub shaft, one or more bearing assemblies, and a hub; and by a fastening assembly, affixing the hub to the hub shaft.

In some embodiments, the hub shaft and the hub extend along a rotation axis.

In some embodiments, inserting the hub includes: sliding an axial bore of the hub onto the hub shaft to dispose a portion of the hub between the hub shaft and the one or more bearing assemblies.

In some embodiments, affixing the hub is by applying an axial force by the fastening assembly.

Some embodiments include, by the fastening assembly: preloading the one or more bearing assemblies in an axial direction.

Some embodiments include preloading the one or more bearing assemblies in an axial direction by screwing a castle nut of the fastening assembly onto the hub shaft.

In some embodiments, preloading the one or more bearings assemblies prior to assembling the one or more bearing assembly within the cavity of the upright.

In some embodiments, the hub shaft is at least a part of a shaft configured to be powered by a motor, and wherein the method includes coupling the hub shaft to the motor.

Embodiments of the present invention may include a method of preloading of one or more bearing assemblies of a wheel hub assembly, the method may include: in a wheel hub assembly includes a hub shaft, a hub, and one or more bearing assemblies assembled within a cavity of an upright: preloading the one or more bearing assemblies in an axial direction by a fastening assembly affixing the hub to the hub shaft.

In some embodiments, preloading the one or more bearing assemblies includes tightening a castle nut of the fastening assembly, the castle nut being screwed on the hub shaft.

Embodiments of the present invention may include a method of replacing of one or more bearing assemblies of a wheel hub assembly, the method may include: in a wheel hub assembly which may include a hub shaft, a hub, and one or more bearing assemblies assembled within a cavity of an upright, and a fastening assembly affixing the hub to the upright: unfastening the fastening assembly to detach the hub from the hub shaft; through an opening on an outer end of the upright: removing the hub from within the cavity; removing the one or more bearing assemblies; inserting one or more new bearing assemblies; and inserting the hub; and by the fastening assembly, fastening the hub to the hub shaft.

Some embodiments include preloading the one or more new bearing assemblies in an axial direction by the fastening assembly.

Some embodiments include preloading the one or more new bearing assemblies by screwing a castle nut of the fastening assembly on the hub shaft.

### BRIEF DESCRIPTION OF THE DRAWINGS

For a better understanding of embodiments of the invention and to show how the same can be carried into effect, reference is made, purely by way of example, to the accompanying drawings in which like numerals designate corresponding elements or sections throughout.

In the accompanying drawings:

FIG. 1A is a three-dimensional (3D) diagram of a wheel hub assembly including two bearing assemblies and of an upright of a wheel assembly, according to some embodiments of the invention;

FIG. 1B is a partial sectional view of the wheel hub assembly and of the upright along line AA of FIG. 1A, according to some embodiments of the invention;

FIG. 1C is an exploded view of the wheel hub assembly and of the upright of FIG. 1A, according to some embodiments of the invention;

FIG. 1D is an exploded partial sectional view of the wheel hub assembly and of the upright of FIG. 1B, according to some embodiments of the invention;

FIG. 1E is a partial sectional view of the upright, and of a nut and a retaining ring of the wheel hub assembly along line AA of FIG. 1A, according to some embodiments of the invention;

FIG. 1F is a partial sectional view of the wheel hub assembly and of the upright along line AA of FIG. 1A, showing preloading forces applied on bearing assemblies, according to some embodiments of the invention;

FIG. 1G shows a process of assembling the wheel hub assembly of FIGS. 1A-IF to the upright, according to some embodiments of the invention;

FIG. 1H is a 3D diagram of a wheel assembly including an upright and the wheel hub assembly of FIGS. 1A-1G, according to some embodiments of the invention;

FIG. 1I is a partial sectional view of the upright of the wheel assembly along line AA of FIG. 1H, according to some embodiments of the invention;

FIG. 2A is a 3D diagram of a wheel hub assembly having one single bearing assembly and of an upright of a wheel assembly, according to some embodiments of the invention;

FIG. 2B is which is a partial sectional view of the wheel hub assembly and of the upright along line BB of FIG. 2A, according to some embodiments of the invention;

FIG. 2C is an exploded partial sectional view of the wheel hub assembly and of the upright of FIG. 2B, according to some embodiments of the invention;

FIG. 2D shows a process of assembling the wheel hub assembly of FIGS. 2A-2C to the upright, according to some embodiments of the invention;

FIG. 2E is a 3D diagram of a wheel assembly including an upright and the wheel hub assembly of FIGS. 2A-2D, according to some embodiments of the invention;

FIG. 2F is a partial sectional view of the upright of the wheel assembly along line BB of FIG. 2E, according to some embodiments of the invention;

FIG. 3A is a 3D diagram of a wheel hub assembly including a hub shaft acting as a shaft that may be powered by a motor, and of an upright of a wheel assembly, according to some embodiments of the invention;

FIG. 3B is which is a partial sectional view of the wheel hub assembly along and of the upright line CC of FIG. 3A, according to some embodiments of the invention;

FIG. 3C is an exploded partial sectional view of the wheel hub assembly and of the upright of FIG. 3B, according to some embodiments of the invention;

FIG. 3D is a 3D diagram of a wheel assembly including an upright and the wheel hub assembly of FIGS. 3A-3B, according to some embodiments of the invention;

FIG. 3E is a partial sectional view of the upright of the wheel assembly along line CC of FIG. 4D, according to some embodiments of the invention;

FIG. 3F is a 3D diagram of a wheel assembly including the upright, the wheel hub assembly of FIGS. 3A-3C, and a suspension arm, according to some embodiments of the invention;

FIG. 3G is a 3D diagram of the wheel assembly of FIG. 3F showing a transmission assembly disposed within the suspension arm, according to some embodiments of the invention;

FIG. 4A is a 3D diagram of a wheel assembly and of a wheel coupled to the wheel assembly, according to some embodiments of the invention;

FIG. 4B is a partial sectional view of the wheel assembly and of the wheel along line DD of FIG. 4A, according to some embodiments of the invention;

FIG. 5A is a 3D diagram of a wheel corner assembly, according to some embodiments of the invention;

FIG. 5B is a partial sectional view of the wheel corner assembly along line EE of FIG. 5A, according to some embodiments of the invention; and

FIG. 6 is a flowchart of a method of assembling a wheel hub assembly to an upright of a wheel assembly, according to some embodiments of the invention;

FIG. 7 is a flowchart of a method of disassembling a wheel hub assembly from an upright of a wheel assembly, according to some embodiments of the invention;

FIG. 8 is a flowchart of a method of preloading of one or more bearing assemblies of a wheel hub assembly, according to some embodiments of the invention; and

FIG. 9 is a flowchart of a method of replacing of one or more bearing assemblies of a wheel hub assembly, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

Embodiments of the present invention may provide a wheel hub assembly. The wheel hub assembly may be assembled to an upright of a wheel assembly. Embodiments of the present invention may provide a wheel assembly that may include the upright and the wheel hub assembly disclosed herein.

The upright may include an outer end, an inner end that is opposed to the outer end, and a cavity. The upright may include, at its outer end, an opening that may provide an access into the cavity of the upright. The upright may include, at its inner end, a suspension coupler that may couple the upright to a suspension arm. When the upright is coupled to the suspension arm, the inner end of the upright may face towards a reference frame of a vehicle or a sub-frame of a wheel corner assembly that couples the wheel corner assembly to the reference frame of the vehicle, while the outer end of the upright may face away from the reference frame of the vehicle or the sub-frame of the wheel corner assembly. The upright may by steerable, for example about a steering axis extending though the body of the upright.

The wheel hub assembly may include a hub. The hub may be removably insertable into the cavity of the upright through the opening on the outer end of the upright. The hub may extend from within the cavity of the upright external thereto. The hub may include a bore extending through a length of the hub. The wheel hub assembly may include a hub shaft (e.g., an axle). The hub shaft may be removably insertable into the cavity of the upright through the opening on the outer end of the upright. The hub shaft may extend through the bore of the hub from within the cavity of the upright external thereto. The wheel hub assembly may include one or more bearing assemblies. Each of the one or more bearing assemblies may be removably insertable into the cavity of the upright through the opening on the outer end of the upright. Each of the one or more bearing assemblies may include an annular housing surrounding a longitudinal portion of the hub. The annular housing of each of the one or more bearing assemblies may include, disposed within an interior thereof, a plurality of bearing members. The wheel hub assembly may include a fastening assembly. The fastening assembly may affix the hub and the hub shaft together. When affixed by the fastening assembly, the hub shaft and the hub may rotate about a rotation axis as a single unit within the cavity.

One advantage of the disclosed wheel hub assembly is that its components (e.g., the spindle, the hub, the one or more bearing assemblies and/or any other suitable components described herein) may be inserted into the cavity of the upright and assembled within the cavity of the upright through the opening on the outer end of the upright without a need in accessing the wheel hub assembly through the inner end of the upright. In some embodiments, components of the wheel hub assembly may be inserted into and assembled within the cavity of the upright only through the opening on the outer end of the upright. In some embodiments, the upright may prevent an access to the cavity of the upright from the inner end of the upright. For example, the inner end of the upright may be a closed end. This is contrast to prior art wheel hub assemblies that typically require accessing the upright from both the outer end and the inner end of the upright to assemble components of the wheel hub assembly to each other and/or to the upright. Allowing insertion and assembly of the components of the wheel hub assembly from the outer end of the upright may be important in compact wheel corner assemblies and/or in wheel corner assemblies having densely arranged components that may make the access to the inner end of the upright of the wheel hub assembly complex or impossible.

Another advantage of the disclosed wheel hub assembly is that the one or more bearing assemblies thereof may be removably insertable into the cavity of the upright of the wheel hub assembly. Accordingly, in the case of malfunction and/or adjustment requirement (e.g. preloading), the one or more bearing assemblies may be easily replaced and/or adjusted without a need in replacing the entire wheel hub assembly. This in contrast to prior art wheel hub assemblies in which the bearing members are typically embedded within the hub of the wheel hub assembly while any malfunction and/or adjustment requirement of one or more of the bearing members requires replacement of the entire wheel hub assembly.

Another advantage of the disclosed wheel hub assembly is that the components of the wheel hub assembly may be fixated within the cavity of the upright by one or more nuts or hub shafts (e.g., a single nut), screwable into or disposed within the cavity or within the circular projection of the cavity of the upright. Holding the components of the wheel hub assembly within the cavity of the upright by the nuts or bolts may provide more compact wheel hub assembly (e.g., as compared to prior art wheel hub assemblies whose components are typically held with respect to the upright by a plurality of bolts at a surface located diametrically external to the cavity of the upright) without compromising on the size of the one or more bearing assemblies. The fixation is also simplified by using one or more bolts or nuts.

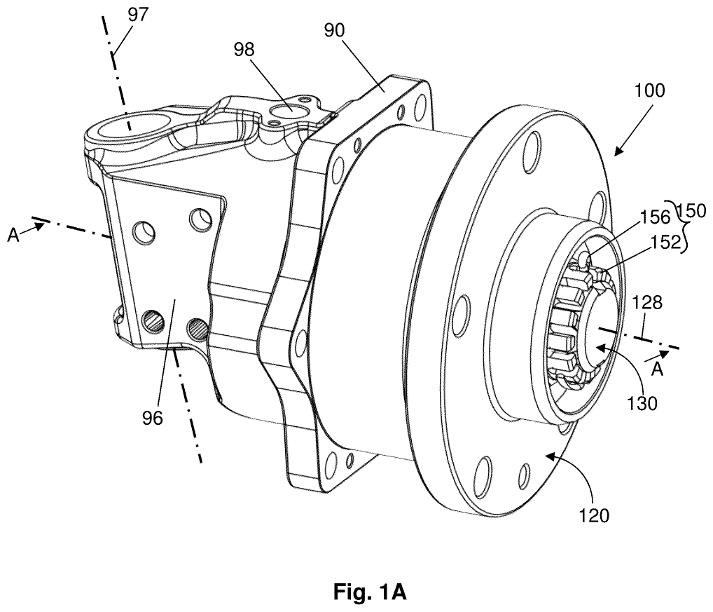

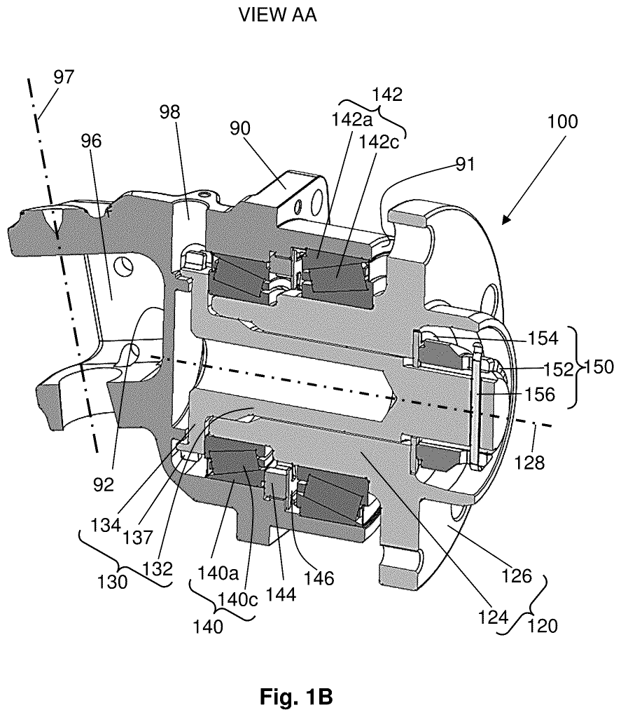

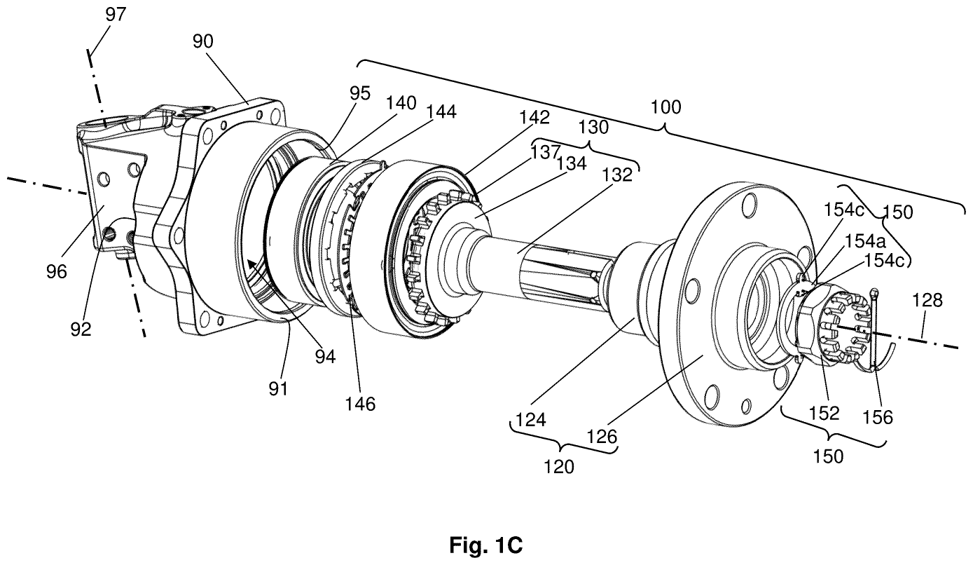

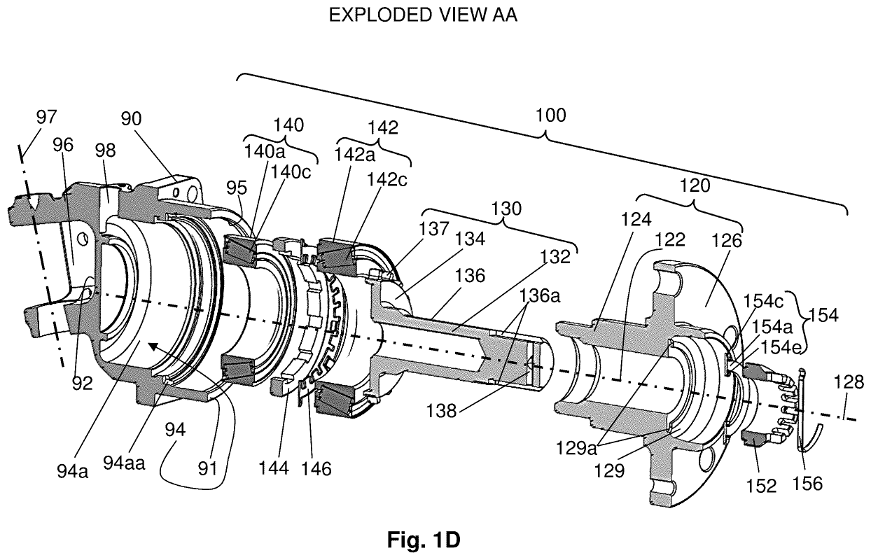

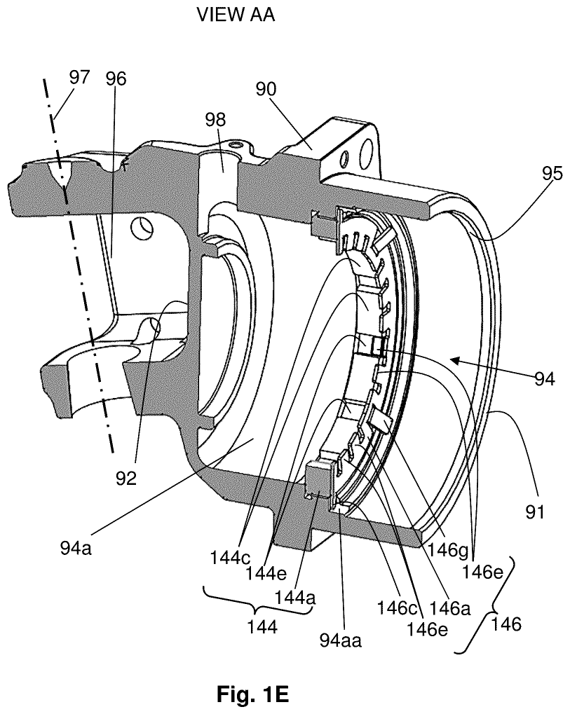

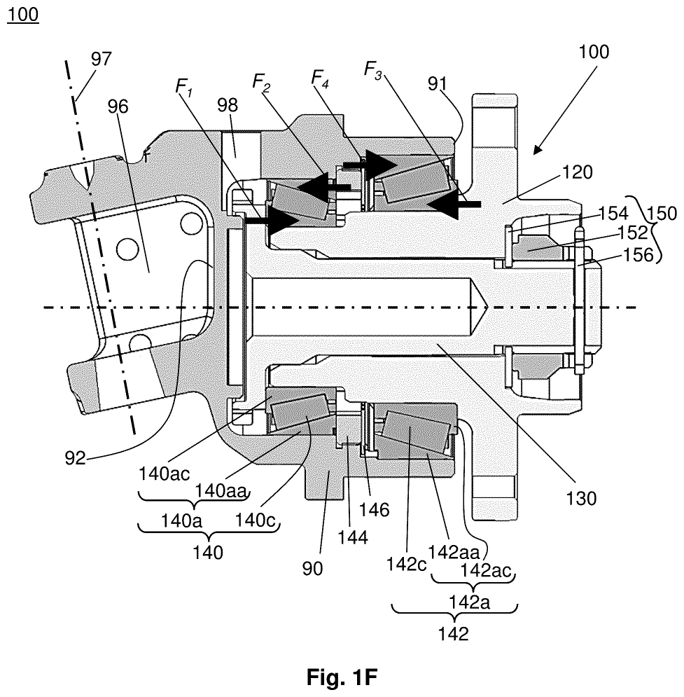

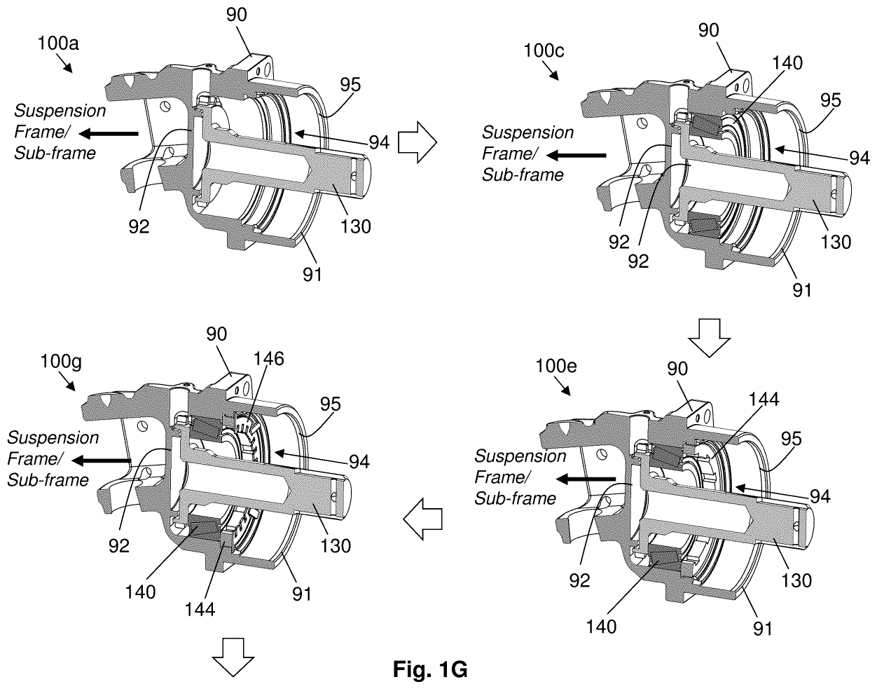

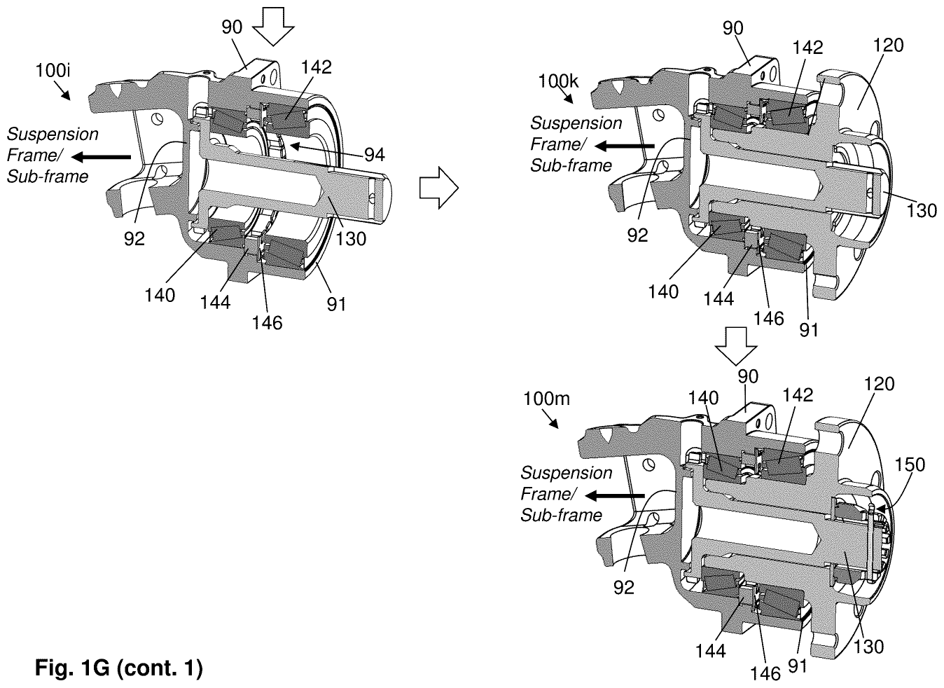

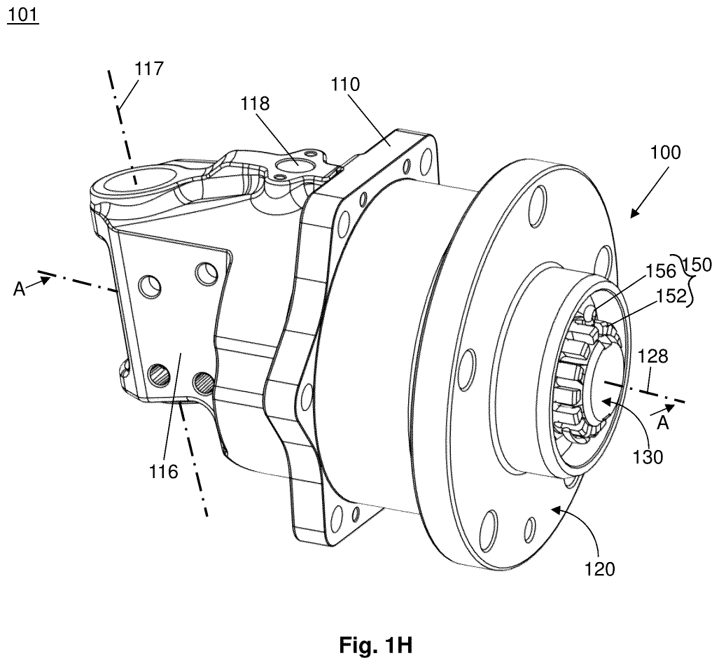

Reference is made to FIG. 1A, which is a 3D diagram of a wheel hub assembly 100 including two bearing assemblies and of an upright 90 of a wheel assembly, according to some embodiments of the invention. FIG. 1A shows a perspective view of wheel hub assembly 100.

Reference is also made to FIG. 1B, which is a partial sectional view of wheel hub assembly 100 and of upright 90 along line AA of FIG. 1A, according to some embodiments of the invention.

Reference is also made to FIG. 1C, which is an exploded view of wheel hub assembly 100 and of upright 90 of FIG. 1A, according to some embodiments of the invention.

Reference is also made to FIG. 1D, which is an exploded partial sectional view of wheel hub assembly 100 and of upright 90 of FIG. 1B, according to some embodiments of the invention.

Reference is also made to FIG. 1E, which is a partial sectional view of upright 90, and of a nut 144 and a retaining ring 146 of wheel hub assembly 100 along line AA of FIG. 1A, according to some embodiments of the invention.

Reference is also made to FIG. 1F, which is a partial sectional view of wheel hub assembly 100 and of upright 90 along line AA of FIG. 1A, showing preloading forces F₁, F₂, F₃, F₄ applied on bearing assemblies 140, 142, according to some embodiments of the invention.

Wheel hub assembly 100 may be assembled to an upright 90. Upright 90 may include an outer end 91, an inner end 92 that is opposed to outer end 91, and a cavity (e.g., hub cavity or axial hub cavity) 94. Cavity 94 may be a cylindrical cavity. Upright 90 may include, at its outer end 91, an opening (e.g., cavity opening) 95. Opening 95 may provide an access to cavity 94. Upright 90 may include, at its inner end 92, a suspension coupler 96. Suspension coupler 96 may couple upright 90 to a suspension arm. Suspension coupler 96 may include bolt holes (e.g., as shown in FIGS. 1A-1F), pins, embedded bushings or any other suitable components known in the art. Inner end 92 of upright 90 may be a closed end. When upright 90 is coupled to the suspension arm, inner end 92 of upright 90 may face towards a reference frame of a vehicle or a sub-frame of a wheel corner assembly that couples the wheel corner assembly to the reference frame of the vehicle, while outer end 91 of upright 90 may face away from the reference frame of the vehicle or the sub-frame of the wheel corner assembly. Upright 90 may be steerable about a steering axis 97. Steering axis 97 may, for example, extend through upright 90. Components of wheel hub assembly 100 may be inserted into and assembled within cavity 94 of upright 90 through opening 95 on outer end 91 of upright 90 without a need in accessing upright 90 from its inner end 92 (e.g., as described herein).

Wheel hub assembly 100 may include a hub 120. Hub 120 may be removably insertable into cavity 94 of upright 90 through opening 95 on outer end 91 of upright 90. Hub 120 may extend from within cavity 94 of upright 90 external thereto through opening 95. Hub 120 may include a bore 122. Bore 122 may extend through the entire length of hub 120. Hub 120 may include a longitudinal portion 124 and a wheel coupling portion 126. Longitudinal portion 124 of hub 120 may have a cylindrical shape. Longitudinal portion 124 of hub 120 may be disposed within cavity 94 of upright 90. Wheel coupling portion 126 of hub 120 may have a circular shape. Wheel coupling portion 126 may extend radially from an outer surface of longitudinal portion 124 of hub 120. Wheel coupling portion 126 of hub 120 may be disposed externally to cavity 94 of upright 90. Wheel coupling portion 126 of hub 120 may include bolt holes or any other suitable components that may couple the wheel to hub 120.

Wheel hub assembly 100 may include a hub shaft (e.g., an axle) 130. Hub shaft 130 may be removably insertable into cavity 94 of upright 90 through opening 95 on outer end 91 of upright 90. Hub shaft 130 may include a longitudinal portion 132 and a base portion 134. Longitudinal portion 132 of hub shaft 130 may have a cylindrical shape. Longitudinal portion 132 of hub shaft 130 may extend through bore 122 of hub 120 from within cavity 94 of upright 90 external thereto through opening 95. Base portion 134 of hub shaft 130 may have a circular shape. Base portion 134 may extend radially from an outer surface of longitudinal portion 132 of hub shaft 130. Base portion 134 of hub shaft 130 may be disposed within cavity 94 of upright 90, for example between longitudinal portion 124 of hub 120 and inner end 92 upright 90. Longitudinal portion 132 of hub shaft 130 may be shaped and sized to abut bore 122 of hub 120. Longitudinal portion 132 of hub shaft 130 and bore 122 of hub 120 may have cylindrical shapes having substantially equal diameters such that bore 122 of hub 120 may be slid axially over longitudinal portion 132 of hub shaft 130 towards base portion 134 of hub shaft 130. In various embodiments, longitudinal portion 132 of hub shaft 130 and bore 122 of hub 120 have polygonal or semi-circular shapes having substantially equal dimensions. Polygonal and/or semi-circular shapes of longitudinal portion 132 of hub shaft 130 and bore 122 of hub 120 may, for example, allow transfer rotational forces between hub shaft 130 and hub 120.

Hub 120 may be affixed (e.g., fastened) to hub shaft 130 by a fastening assembly 150 (e.g., as described herein). When affixed by fastening assembly 150, hub 120 and hub shaft 130 may rotate with respect to upright 90 about a hub shaft/hub rotation axis 128.

Hub shaft 130 may include teeth 137 disposed on an outer side surface of base portion 134 of hub shaft 130. Upright 90 may include a bore 98 formed through a side wall of upright 90 adjacent to inner end 92 of upright 90. Bore 98 of upright 90 may receive and hold a tooth detection sensor (not explicitly shown in FIGS. 1A-IF). The sensor may generate signals indicative of detection of teeth 137 disposed on base portion 134 of hub shaft 130 while hub shaft 130 is rotating. Based on the signals, the rotation speed of hub shaft 130 and hub 120 may be determined.

Wheel hub assembly 100 may include a first (e.g., inner) bearing assembly 140 and a second (e.g., outer) bearing assembly 142. First bearing assembly 140 may be disposed within cavity 94 of upright 90 deeper relative to opening 95 on outer end 91 of upright 90 than second bearing assembly 142. For example, first bearing assembly 140 may be disposed adjacent to base portion 134 of hub shaft 130 and/or inner end 92 of upright 90 and second bearing assembly 142 may be disposed adjacent to opening 95 on outer end 91 of upright 90.

First bearing assembly 140 may be removably insertable into cavity 94 of upright 90 through opening 95 on outer end 91 of upright 90. First bearing assembly 140 may include an annular housing 140a and a plurality of bearing members 140c disposed within an interior of annular housing 140a. Annular housing 140a of first bearing assembly 140 may surround a first part of longitudinal portion 124 of hub 120.

Wheel hub assembly 100 may include a nut 144. Nut 144 may be removably insertable into cavity 94 of upright 90 through opening 95 on outer end 91 of upright 90. Nut 144 may be screwed into cavity 94. Nut 144 may have an external thread that mates with an internal thread on an inner side wall 94a of cavity 94 (threads are not shown in FIGS. 1A-IF for simplicity). When screwed into cavity 94, nut 144 may hold first bearing assembly 140 and hub shaft 130 with respect to cavity 94 in an axial direction. The axial direction is a direction that is parallel to rotation axis 128.

Nut 144 may include an annular portion 144a and a plurality of inner projections 144c projecting inwardly from annular portion 144a in the radial direction such that a gap 144e is formed between each two inner projections 144c (e.g., as indicated in FIG. 1E). Gaps 144e may be used to fasten nut 144 to inner side wall 94a of cavity 94. For example, a nut fastening tool may be inserted in one or more of gaps 144c.

Wheel hub assembly 140 may include a retaining ring 146. Retaining ring 146 may be disposed between nut 144 and second bearing assembly 142. Retaining ring 146 may be removably inserted into cavity 94 of upright 90 through opening 95 on outer end 91 of upright 90. Retaining ring 146 may prevent nut 144 from unintentionally unscrewing from within cavity 94 of upright 90. Retaining ring 146 may engage with inner side wall 94a of cavity 94 of upright 90 and with nut 144 so as to prevent nut 144 from unintentionally unscrewing from within cavity 94 of upright 90.

For example, retaining ring 146 may include an annular portion 146a (e.g., as indicated in FIG. 1E). Retaining ring 146 may include one or more outer projections 146c projecting outwardly from an outer edge of annular portion 146a of retaining ring 146 in the radial direction (e.g., as indicated in FIG. 1E). One or more outer projections 146c of annular portion 146a of retaining ring 146 may engage with one or more mating indents 114aa on inner side wall 94a of cavity 94 to prevent retaining ring 146 from rotating within cavity 94. Retaining ring 146 may include one or more inner projections 146e projecting inwardly from annular portion 146a of retaining ring 146 in the radial direction (e.g., as indicated in FIG. 1E). When retaining ring 144 is properly disposed within cavity 94 of upright 90, one (or more) of inner projections 146e of retaining ring 146 may be aligned with respective one (or more) of gaps 144e of nut 144 for any angular position of nut 144. For example, the number and/or size of inner projections 146e and the number and/or size of inner projections 144e of nut 144 may ensures that one (or more) of inner projections 146e of retaining ring 146 may be aligned with respective one (or more) of gaps 144c of nut 144 for any angular position of nut 144. The respective inner projection 146e may be bent into the respective gap 144c so as to prevent nut 144 from rotating and unintentionally unscrewing from within cavity 94 of upright 90 (e.g., as shown in FIG. 1E).

Retaining ring 146 may include a plurality of resilient members 146g projecting from annular portion 146a of retaining ring 146 in the axial direction (e.g., as indicated in FIG. 1E). Resilient members 146g may push second bearing assembly 142 in the axial direction to take part in preloading of second bearing assembly 142 (e.g., as described hereinbelow).

Second bearing assembly 142 may be removably insertable into cavity 94 of upright 90 through opening 95 on outer end 91 of upright 90. Second bearing assembly 142 may include an annular housing 142a and a plurality of bearing members 142c disposed within an interior of annular housing 142a. Annular housing 142a of second bearing assembly 142 may surround a second part of longitudinal portion 124 of hub 120. Second bearing assembly 142 may be disposed between retaining ring 146 and wheel coupling portion 126 of hub 120.

Each of first bearing assembly 140 and second bearing assembly 142 may be a tapered rolling bearing assembly (e.g. as shown in FIGS. 1B and 1D). First bearing assembly 140 and second bearing assembly 142 may be tapered in opposite directions (e.g. as shown in FIGS. 1B and 1D). First bearing assembly 140 and second bearing assembly 142 that are tapered in opposite directions may, for example, allow wheel hub assembly 100 to absorb forces applied thereon in the opposite axial directions. In various embodiments, each of first bearing assembly 140 and/or second bearing assembly 142 may be an angular contact bearing assembly.

Wheel hub assembly 100 may include a fastening assembly 150. Fastening assembly 150 may include a castle nut 152. Castle nut 152 may be screwed onto hub shaft 130. Castle nut 152 may have an internal thread that mates with an external thread on hub shaft 130 (threads are not shown in FIGS. 1A-IF for simplicity). When screwed onto hub shaft 130, castle nut 152 may hold hub 120 with respect to hub shaft 130 in the axial direction and cause hub 120 (e.g., wheel coupling portion 126 of hub 120) to hold second bearing assembly 142 within cavity 94 of upright 90.

When screwed onto hub shaft 130, castle nut 152 may preload first bearing assembly 140 and second bearing assembly 142 in the axial direction. When screwed onto hub shaft 130, castle nut 152 may cause hub shaft 130 (e.g., base portion 134 of hub shaft 130) and nut 140 to apply opposing axial forces F₁, F₂, respectively, on first bearing assembly 140 to preload first bearing assembly 140 in the axial direction. When screwed onto hub shaft 130, castle nut 152 may cause hub 120 (e.g., wheel coupling portion 126 of hub 120) and nut 140 (or retaining ring 146 if used (e.g., one or more resilient members 146g of retaining ring 146)) to apply opposing axial forces F₃, F₄, respectively, on second bearing assembly 142 to preload second bearing assembly 142 in the axial direction (e.g. as indicated in FIG. 1F). For example, when screwed onto hub shaft 130, castle nut 152 may pull hub shaft 130 in a direction extending from inner end 92 towards outer end 91 of upright 90 to cause hub shaft 130 (e.g., base portion 134 of hub shaft 130) to apply axial force F₁ on an outer ring 140aa of annular housing 140a of first bearing assembly 140 in the direction extending from inner end 92 towards outer end 91 of upright 91, and cause nut 144 to apply axial force F₂ on an inner ring 140ac of annular housing 140a of first bearing assembly 140 in a direction extending from outer end 91 towards inner end 92 of upright 90 (e.g., as shown in FIG. 1F). In the same example, when screwed onto hub shaft 130, castle nut 152 may push hub 120 towards cavity 94 of upright 90 to cause hub 120 (e.g., wheel coupling portion 126 of hub 120) to apply axial force F₃ on an inner ring 142ac of annular housing 142a of second bearing assembly 142 in the direction extending from outer end 91 towards inner end 92 of upright 90, and cause retaining ring 146 (e.g., one or more resilient members 146g of retaining ring 146) to apply axial force F₄ on an outer ring 142ac of annular housing 142a of second bearing assembly 142 in the direction extending from inner end 92 towards outer end 91 of upright 90 (e.g., as shown in FIG. 1F).

Fastening assembly 150 may include a washer 154. Washer 154 may be disposed between hub 120 and castle nut 152. Washer 154 may engage with hub 120 and hub shaft 130 to hold hub 120 with respect to hub shaft 130 in the radial direction so as to cause hub 120 and hub shaft 130 to rotate as a single unit about rotation axis 128. For example, washer 154 may include an annular portion 154a, one or more outer projections 154c projecting outwardly from annular portion 154a in the radial direction and one or more inner projections 154c projecting inwardly from annular portion 154a in the radial direction. When washer 154 is properly disposed with respect to hub 120 and hub shaft 130, one or more outer projections 154c may engage with one or more indents 129a on an inner side wall 129 of hub 120 and one or more inner projections 154e may engage with one or more indents 135A on an outer surface 136 of hub shaft 130 so as to hold hub 120 with respect to hub shaft 130 in the radial direction.

Fastening assembly 150 may include a cotter pin 156. Cotter pin 156 may be inserted through opposing slots of castle nut 152 and through a transverse bore 138 formed through hub shaft 130 and then bent to prevent castle nut 152 from unintentionally unscrewing from hub shaft 130.

Reference is made to FIG. 1G, which shows a process of assembling wheel hub assembly 100 of FIGS. 1A-IF to upright 90, according to some embodiments of the invention. For clarity, FIG. 1G show partial sectional view of components of wheel hub assembly 100 along line AA of FIG. 1A.

In operation 100a, hub shaft 130 may inserted into cavity 94 of upright 90 through opening 95 on outer end 91 of upright 90.

In operation 100c, first bearing assembly 140 may be inserted into cavity 94 of upright 90 through opening 95 on outer end 91 of upright 90.

In operation 100e, nut 144 may be inserted into cavity 94 of upright 90 through opening 95 on outer end 91 of upright 90. Nut 144 may be screwed into cavity 94 of upright 90 to hold first bearing assembly 140 and hub shaft 130 within cavity 94 with respect to upright 90.

In operation 100g, retaining ring 146 may be inserted into cavity 94 of upright 90 through opening 115 on outer end 91 of upright 90. Retaining ring 146 may engage with upright 90 and nut 144 to prevent nut 144 from unintentionally unscrewing from within cavity 94.

In operation 100i, second bearing assembly 142 may be inserted into cavity 94 of upright 90 through opening 115 on outer end 91 of upright 90.

In operation 100k, hub 120 may be inserted into cavity 94 of upright 90 through opening 115 on outer end 91 of upright 90.

In operation 100m, hub 120 may be affixed to hub shaft 130 by fastening assembly 150 (e.g., as described hereabove). When affixed to hub shaft 130, hub 120 may hold second bearing assembly 142 within cavity 94 of upright 90. First bearing assembly 140 and second bearing assembly 142 may be preloaded in the axial direction by screwing castle nut 152 of fastening assembly 150 on hub shaft 130 (e.g., as described hereinabove).

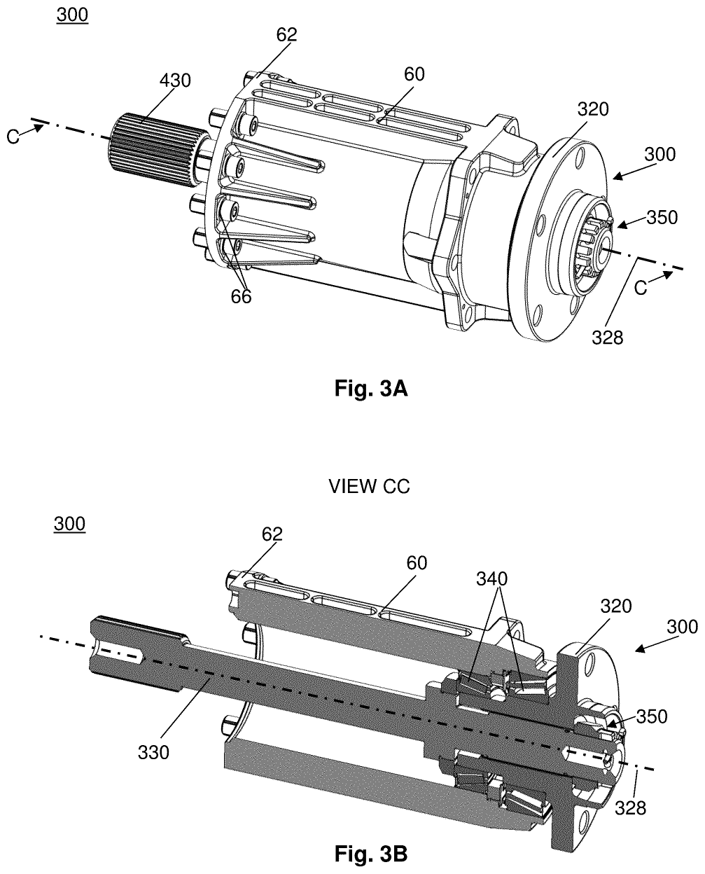

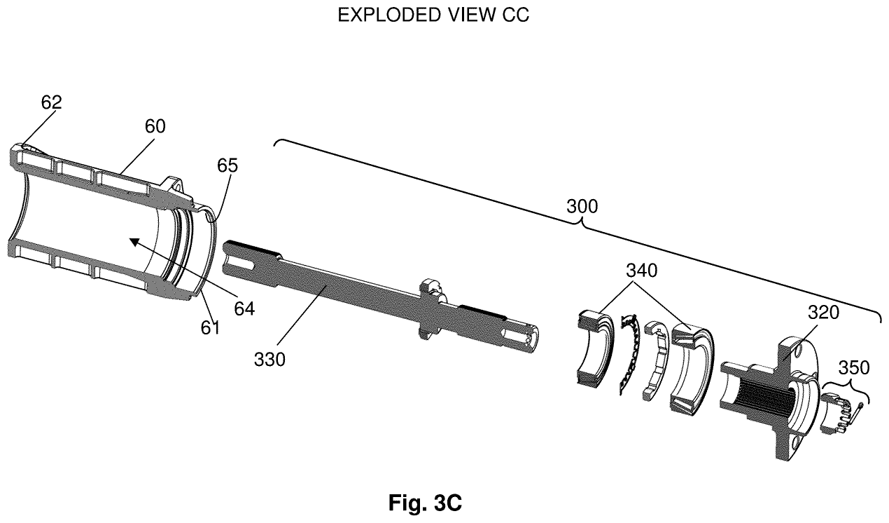

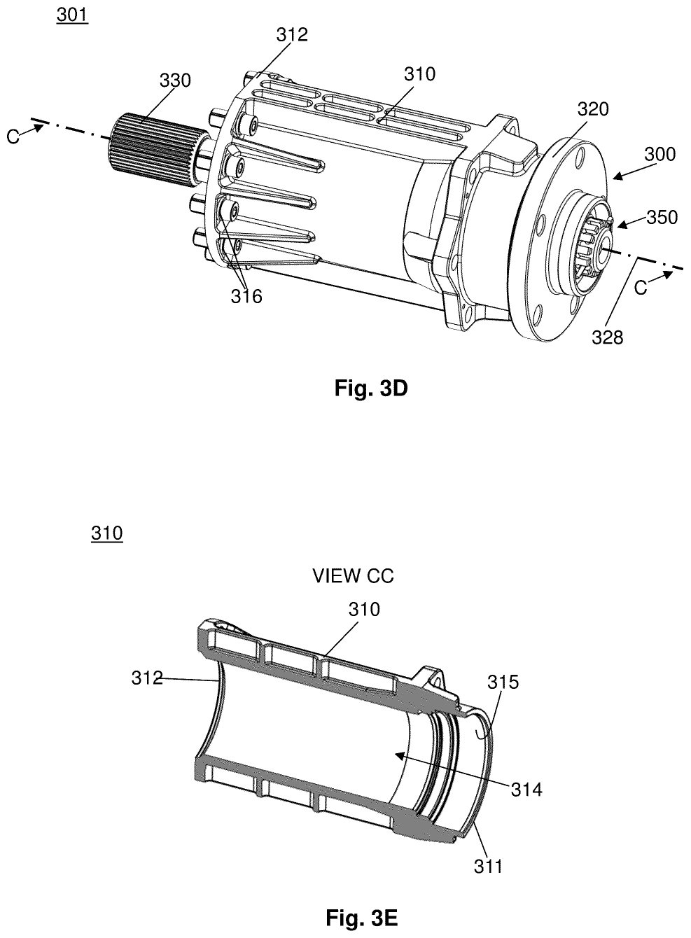

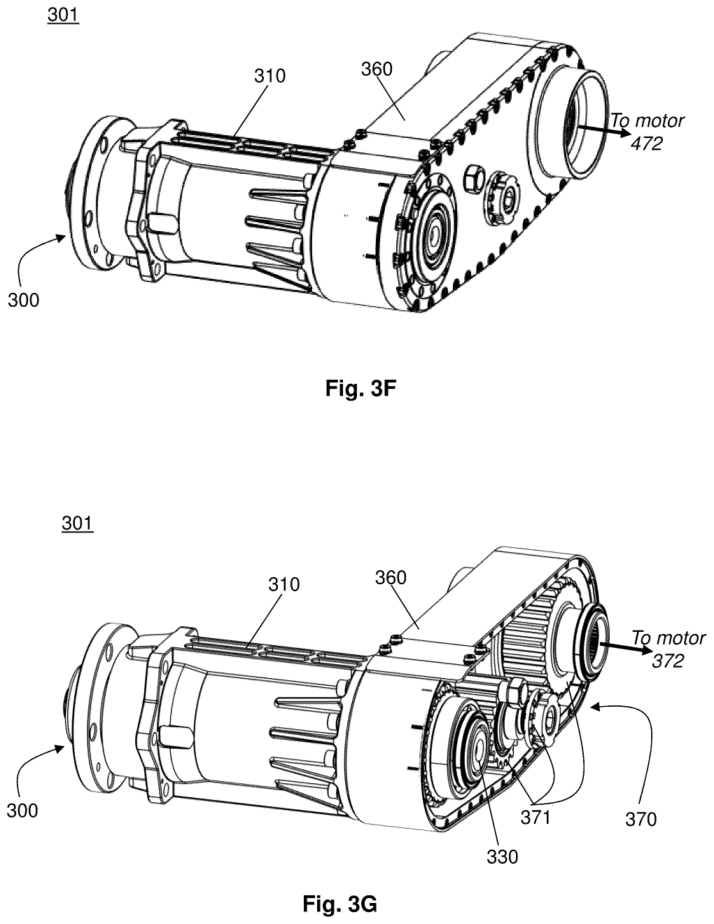

As shown in FIG. 1G, components of wheel hub assembly 100 may be inserted into and assembled within cavity 94 of upright 90 through opening 95 on outer end 91 of upright 90 without a need in accessing wheel hub assembly 100 from inner end 92 of upright 90 (which may be closed as in the example of FIGS. 1A-1G). This is contrast to prior art wheel hub assemblies that typically require accessing the wheel hub assembly from both the inner end and the outer end of the upright to assemble components of the wheel hub assembly to each other. Allowing insertion and assembly of the components of wheel hub assembly 100 from outer end 91 of upright 90 may be important in compact wheel corner assemblies and/or in wheel corner assemblies having densely arranged components that may make the access to inner end 92 of upright 90 of wheel hub assembly 100 complex or impossible. One example of a suspension arm that prevents an access into the cavity of the upright through the inner end of the upright is described below with respect to FIGS. 3A and 3B.

As shown in FIG. 1G, bearing assemblies 140, 142 may be removably assemblable within cavity 94 of upright 90. In the case of malfunction, bearing assemblies 140, 142 may be easily disassembled from within cavity 94 of upright 90 and replaced with new bearing assemblies. Furthermore, bearing assemblies 140, 142 may be adjusted (e.g., preloaded) by tightening castle nut 152 of fastening assembly 150 (e.g., as described hereinabove). This in contrast to prior art wheel hub assemblies in which bearing assemblies are typically embedded within the hub and any malfunction in the bearing assemblies requires replacement of the hub and/or of the entire wheel hub assembly. Having removably insertable bearing assemblies 140, 142 may simplify the maintenance of wheel hub assembly 100 as compared to prior art wheel hub assemblies.

Wheel hub assembly 100 may be disassembled from upright 90 by performing operations 100a to 100m described with respect to FIG. 1G in a reversed order. For example, fastening assembly 150 may be unfastened from hub shaft 130 to detach hub 120 from hub shaft 130. Hub 120 may be removed from within cavity 94 of upright 90 through opening 95 on outer end 91 of upright 90. Second bearing assembly 140 may be removed from within cavity 94 of upright 90 through opening 95 on outer end 91 of upright 90. Retaining ring 146 may be then removed from within cavity 94 of upright 90 through opening 95 on outer end 91 of upright 90 to allow nut 144 to be unscrewed from within cavity 94 of upright 90. Nut 144 may be unscrewed and removed from within cavity 94 of upright 90 through opening 95 on outer end 91 of upright 90. First bearing assembly 140 may be then removed from within cavity 94 of upright 90 through opening 95 on outer end 91 of upright 90. Hub shaft 130 may be then removed from within cavity 94 of upright 90 through opening 95 on outer end 91 of upright 90.

Reference is made to FIG. 1H, which is a 3D diagram of a wheel assembly 101 including an upright 110 and wheel hub assembly 100 of FIGS. 1A-1G, according to some embodiments of the invention.

Reference is also made to FIG. 1I, which is a partial sectional view of upright 110 of wheel assembly 101 along line AA of FIG. 1H, according to some embodiments of the invention.

Embodiments of the present invention may provide wheel assembly 101 that may include upright 110 (e.g., such as upright 90 as described hereinabove) and wheel hub assembly 100 (e.g., as described hereinabove).

Upright 110 may include an outer end 111, an inner end 112 that is opposed to outer end 111, and a cavity (e.g., hub cavity or axial hub cavity) 114. Cavity 114 may be a cylindrical cavity. Upright 110 may include, at its outer end 111, an opening (e.g., cavity opening) 115. Opening 115 may provide an access to cavity 114. Upright 110 may include, at its inner end 112, a suspension coupler 116. Suspension coupler 116 may couple upright 110 to a suspension arm. Suspension coupler 116 may include bolt holes, pins, embedded bushings or any other suitable components known in the art. Inner end 112 of upright 110 may be a closed end. When upright 110 is coupled to the suspension arm, inner end 112 of upright 110 may face towards a reference frame of a vehicle or a sub-frame of a wheel corner assembly that couples the wheel corner assembly to the reference frame of the vehicle, while outer end 111 of upright 110 may face away from the reference frame of the vehicle or the sub-frame of the wheel corner assembly. Components of wheel hub assembly 100 may be inserted into and assembled within cavity 114 of upright 110 through opening 115 on outer end 111 of upright 110 without a need in accessing upright 110 from its inner end 112 (e.g., as described above with respect to FIGS. 1A-1G). Upright 110 may be steerable about a steering axis 117. Steering axis 117 may, for example, extend through upright 110. Upright 110 may include a bore 118 formed through a side wall of upright 110 adjacent to inner end 112 of upright 110. Bore 118 of upright 110 may receive and hold a tooth detection sensor that may act as rotation speed sensor (e.g., as described above with respect to FIGS. 1A-1G).

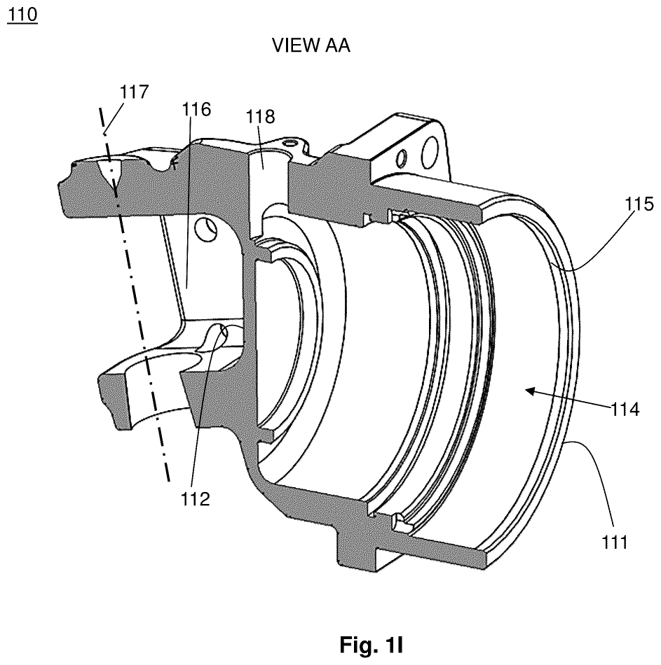

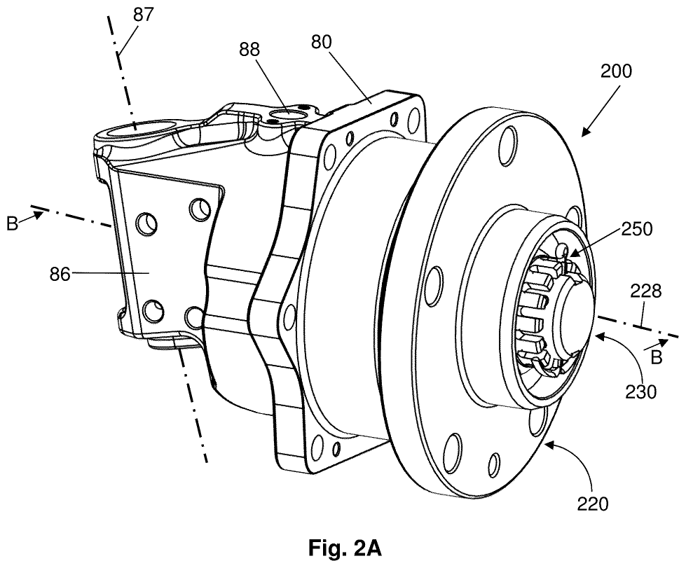

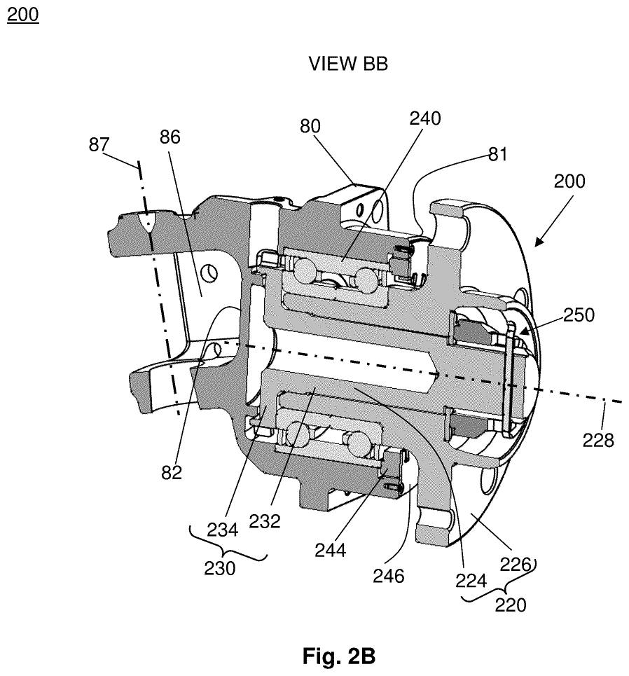

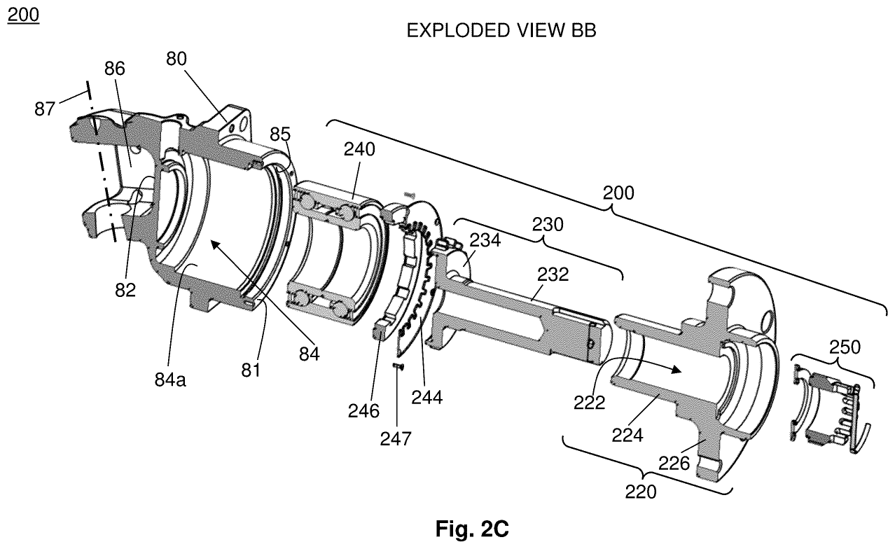

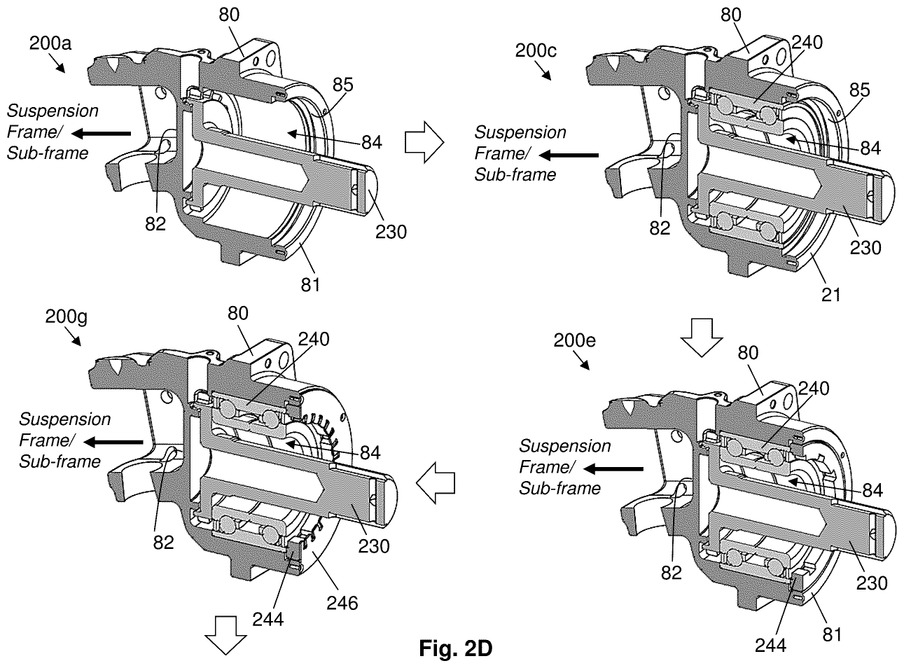

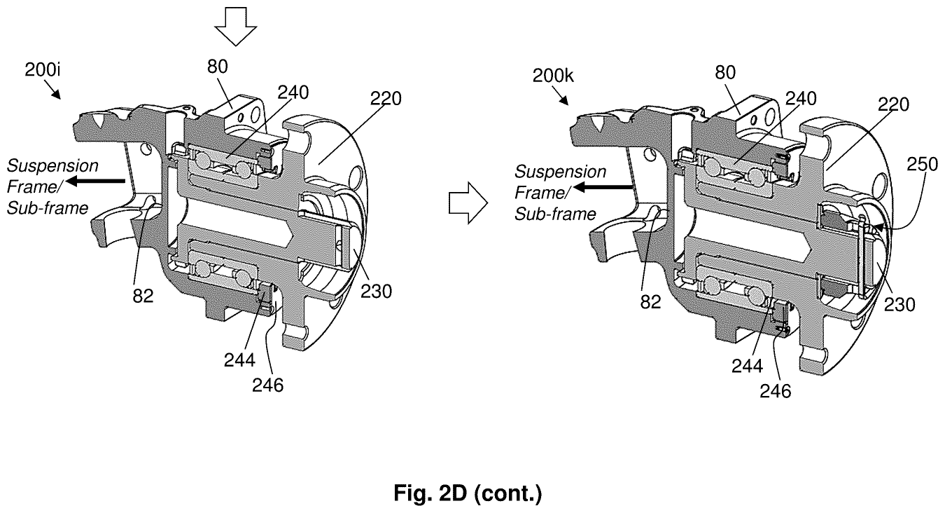

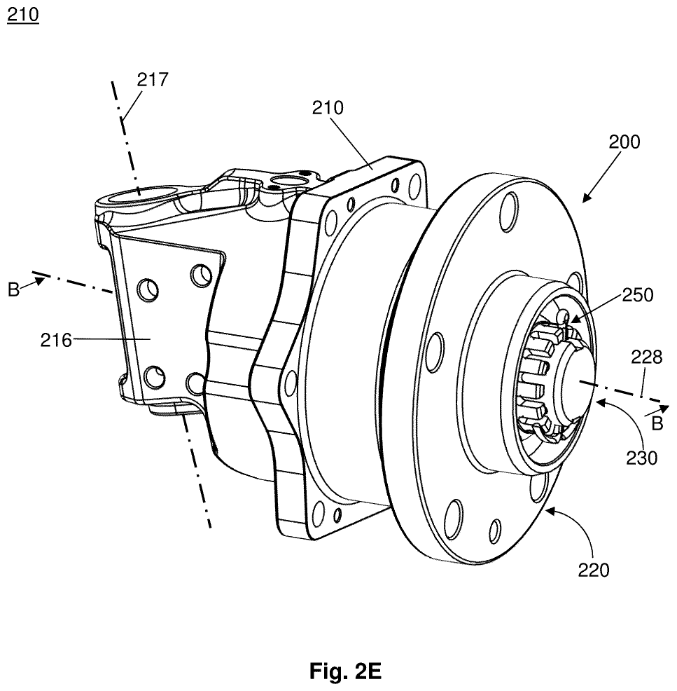

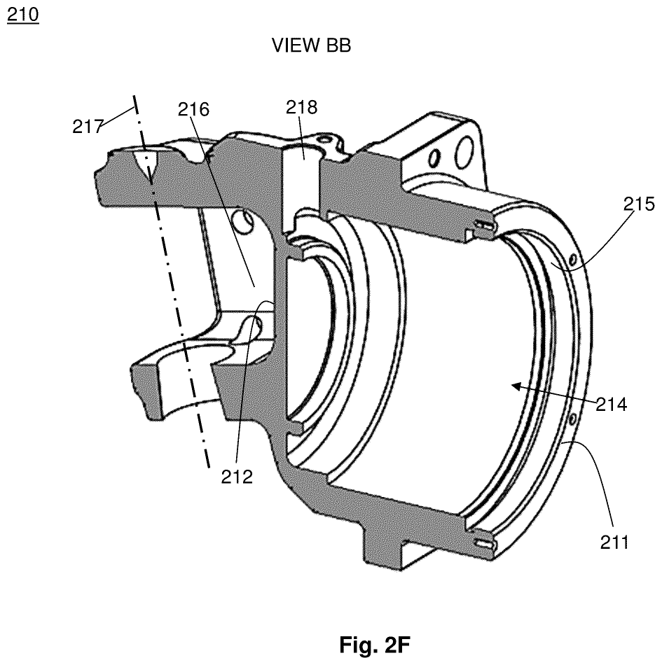

Reference is made to FIG. 2A, which is a 3D diagram of a wheel hub assembly 200 having one bearing assembly 240 and of an upright 80 of a wheel assembly, according to some embodiments of the invention.

Reference is also made to FIG. 2B, which is which is a partial sectional view of wheel hub assembly 200 and of upright 80 along line BB of FIG. 2A, according to some embodiments of the invention.

Reference is also made to FIG. 2C, which is an exploded partial sectional view of wheel hub assembly 200 and upright 80 of FIG. 2B, according to some embodiments of the invention.

Wheel hub assembly 200 may be coupled to an upright 80. Wheel hub assembly may include a hub 220, a hub shaft 230, a bearing assembly (e.g., one bearing assembly) 240 and a fastening assembly 250 and/or any other suitable components described herein and/or known in the art.

Upright 80 may include an outer (e.g., open) end 81 having an opening (e.g., cavity opening) 85 that provides an access to a cavity (e.g., hub cavity or axial hub cavity) 84 of upright 80, and an inner (e.g. closed) end 82 having a suspension coupler 86 that may couple upright 80 to a suspension arm. Upright 80 may be steerable about a steering axis 87 (e.g., that may extend through upright 80).

Components of wheel hub assembly 200 may be inserted into and assembled within cavity 84 of upright 80 through opening 85 on outer end 81 of upright 80 without a need in accessing upright 80 from its inner end 82 (e.g., as described hereinabove). This may be advantageous over prior art wheel hub assemblies (e.g., as described hereinabove).

Bearing assembly 240 may include 240 one or more bearings. Bearing assembly 240 may include a plurality of bearings having a common internal diameter. Bearing assembly 240 may include a plurality of bearings having a common outer diameter. Bearing assembly 240 may have an outer diameter sized to abut an inner side wall 84a of cavity 84.

Bearing assembly 240 may be removably assemblable within cavity 84 of upright 80 (e.g., in a similar way as described hereinabove). This feature may be advantageous over prior art wheel hub assemblies (e.g., as described hereinabove). Bearing assembly 240 may be preloaded prior to assembling bearing assembly 240 within cavity 84 of upright 80. When assembled within cavity 84 of upright 80, bearing assembly 240 may surround at least a part of a longitudinal portion of hub 220 (e.g., as shown in FIG. 2B). Bearing assembly 240 and hub shaft 230 may be held within cavity 84 of upright 80 by a nut 244 (e.g., such as nut 144) screwable into cavity 84 of upright 80 through opening 85 on outer end 81 of upright 80 to hold bearing assembly 240. Wheel hub assembly 240 may include a retaining ring 246. Retaining ring 246 may prevent nut 244 from unintentionally unscrewing from within cavity 84 of upright 80. Retaining ring 246 may engage with upright 80 (e.g., using bolts 247 or any other suitable means known in the art) and with nut 244 (e.g., as described hereinabove) so as to prevent nut 244 from unintentionally unscrewing from within cavity 84 of upright 80. Fastening assembly 250 may affix hub 220 and hub shaft 230 together (e.g., as described hereinabove).

Hub 220 may include a bore 222, a longitudinal portion 224 and a wheel coupling portion 226. Longitudinal portion 224 of hub 220 may be disposed within cavity 84 of upright 80. Wheel coupling portion 226 of hub 220 may be disposed externally to cavity 84 of upright 80. Hub shaft 230 may include a longitudinal portion 232 and a base portion 234. Longitudinal portion 232 of hub shaft 230 may extend through bore 222 of hub 220 from within cavity 84 of upright 80 external thereto through opening 85. Longitudinal portion 232 of hub shaft 230 may be shaped and sized to abut bore 222 of hub 220. Longitudinal portion 232 of hub shaft 230 and bore 222 of hub 220 may have cylindrical shapes having substantially equal diameters such that bore 222 of hub 220 may be slid axially over longitudinal portion 232 of hub shaft 230 towards base portion 234 of hub shaft 230. In various embodiments, longitudinal portion 232 of hub shaft 230 and bore 222 of hub 220 have polygonal or semi-circular shapes having substantially equal dimensions. Polygonal and/or semi-circular shapes of longitudinal portion 232 of hub shaft 230 and bore 222 of hub 220 may, for example, allow transfer rotational forces between hub shaft 230 and hub 220.

Reference is made to FIG. 2D, which shows a process of assembling the wheel hub assembly of FIGS. 2A-2C to the upright, according to some embodiments of the invention. For clarity, FIG. 2D show partial sectional view of components of wheel hub assembly 200 along line AA of FIG. 2A.

In operation 200a, hub shaft 230 may inserted into cavity 94 of upright 80 through opening 85 on outer end 81 of upright 80.

In operation 200c, bearing assembly 240 may be inserted into cavity 84 of upright 80 through opening 85 on outer end 81 of upright 80.

In operation 200c, nut 244 may be inserted into cavity 84 of upright 80 through opening 85 on outer end 81 of upright 80. Nut 244 may be screwed into cavity 84 of upright 80 to hold bearing assembly 240 and hub shaft 230 within cavity 84 with respect to upright 80.

In operation 200g, retaining ring 246 may be engaged with upright 80 and nut 244 to prevent nut 244 from unintentionally unscrewing from within cavity 84.

In operation 200i, hub 220 may be inserted into cavity 84 of upright 80 through opening 85 on outer end 81 of upright 80.

In operation 200k, hub 220 may be affixed to hub shaft 230 by fastening assembly 250 (e.g., as described hereabove).

Wheel hub assembly 200 may be disassembled from upright 80 by performing operations 100a to 100k described with respect to FIG. 2D in a reversed order. For example, fastening assembly 250 may be unfastened from hub shaft 230 to detach hub 220 from hub shaft 230. Hub 220 may be removed from within cavity 84 of upright 80 through opening 85 on outer end 81 of upright 80. Retaining ring 246 may be then removed from within upright 80 to allow nut 244 to be unscrewed from within cavity 84 of upright 80. Nut 244 may be unscrewed and removed from within cavity 84 of upright 80 through opening 85 on outer end 81 of upright 80. Bearing assembly 240 may be then removed from within cavity 84 of upright 80 through opening 85 on outer end 81 of upright 80. Hub shaft 230 may be then removed from within cavity 84 of upright 80 through opening 85 on outer end 81 of upright 80.

Reference is made to FIG. 2E, which is a 3D diagram of a wheel assembly 201 including an upright 210 and wheel hub assembly 200 of FIGS. 2A-2D, according to some embodiments of the invention.

Reference is also made to FIG. 2F, which is a partial sectional view of upright 210 of wheel assembly 201 along line AA of FIG. 2E, according to some embodiments of the invention.

Embodiments of the present invention may provide wheel assembly 201 that may include upright 210 (e.g., such as upright 80 as described above with respect to FIGS. 2A-2D) and wheel hub assembly 200 (e.g., as described above with respect to FIGS. 2A-2D).

Upright 210 may include an outer (e.g., open) end 211 having an opening (e.g., cavity opening) 215 that provides an access to a cavity (e.g., hub cavity or axial hub cavity) 214 of upright 200, and an inner (e.g. closed) end 212 having a suspension coupler 216 that may couple upright 210 to a suspension arm. Upright 210 may be steerable about a steering axis 217. Steering axis 217 may, for example, extend through upright 210. Upright 210 may include a bore 218 formed through a side wall of upright 210 adjacent to inner end 212 of upright 210. Bore 218 of upright 210 may receive and hold a tooth detection sensor that may act as rotation speed sensor (e.g., as described above with respect to FIGS. 1A-1G).

Reference is made to FIG. 3A, which is a 3D diagram of a wheel hub assembly 300 including a hub shaft 330 acting as a shaft that may be powered by a motor, and of an upright 60 of a wheel assembly, according to some embodiments of the invention.

Reference is also made to FIG. 3B, which is which is a partial sectional view of wheel hub assembly 300 and of upright 60 along line CC of FIG. 3A, according to some embodiments of the invention.

Reference is also made to FIG. 3C, which is an exploded partial sectional view of wheel hub assembly 300 and of upright 60 of FIG. 3B, according to some embodiments of the invention.

Wheel hub assembly 300 may include a hub 320, a hub shaft 330, one or more bearing assemblies 340 (e.g., one bearing assembly or two bearing assemblies as described hereinabove), a fastening assembly 350 and/or any other suitable components described herein and/or known in the art.

Upright 60 may include an outer end 61 having an opening (e.g., cavity opening) 65 that provides an access to a cavity (e.g., hub cavity) 64 of upright 60, and an inner end 62 having a suspension coupler 66 that may couple upright 60 to a suspension arm.

Components of wheel hub assembly 300 may be inserted into and assembled within cavity 64 of upright 60 only through opening 65 on outer end 61 of upright 60 without a need in accessing upright 60 from its inner end 62 (e.g., as described hereinabove).

Hub shaft 330 may be a shaft or part of the shaft that may be powered by a motor. When powered, hub shaft 330 may rotate together with hub 320 of wheel hub assembly 300 about a rotation axis 328 (e.g., as described hereinabove). Hub shaft 330 may be coupled to the motor directly or indirectly, for example by a transmission assembly. Hub shaft 330 may be coupled to a driveshaft or a Cardan shaft. Hub shaft 330 may be part of a driveshaft, a transmission shaft or a Cardan shaft. Hub shaft 330 may be a driveshaft, a transmission shaft or a Cardan shaft.

Wheel hub assembly 300 may be assembled to and disassembled from upright 60 like wheel hub assembly 100 to upright 90 or like wheel hub assembly 200 to upright 80 as described hereinabove, while hub shaft 330 may be coupled (e.g., at one end thereof) to the motor or to the transmission assembly that may couple hub shaft 330 to the motor.

Reference is made to FIG. 3D, which is a 3D diagram of a wheel assembly 301 including an upright 310 and wheel hub assembly 300 of FIGS. 3A-3C, according to some embodiments of the invention.

Reference is also made to FIG. 3E, which is a partial sectional view of upright 310 of wheel assembly 301 along line CC of FIG. 3D, according to some embodiments of the invention.

Embodiments of the present invention may provide wheel assembly 301 that may include upright 310 (e.g., such as upright 60 as described hereinabove) and wheel hub assembly 300 (e.g., as described hereinabove).

Upright 310 may include an outer end 311 having an opening (e.g., cavity opening) 315 that provides an access to a cavity (e.g., hub cavity) 314 of upright 300, and an inner end 312 having a suspension coupler 316 that may couple upright 310 to a suspension arm. Both outer end 311 and inner end 312 of upright 310 may be open ends to allow passage of hub shaft 330 through the entire length of cavity 314 of upright 314 external thereto.

Reference is made to FIG. 3F, which is a 3D diagram of a wheel assembly 301 including an upright 310, wheel hub assembly 300 of FIGS. 3A-3C, and a suspension arm 360, according to some embodiments of the invention.

Reference is made to FIG. 3G, which is a 3D diagram of a wheel assembly 301 of FIG. 3F showing a transmission assembly 370 disposed within suspension arm 360, according to some embodiments of the invention.

In the example of FIGS. 3F and 3G, hub shaft 330 of wheel hub assembly 300 extends through the entire length of cavity 314 of upright 310 of wheel assembly 301 and may be coupled to a transmission assembly 370. Transmission assembly 370 may be, for example, disposed within suspension arm 360 of wheel assembly 301 (e.g., as shown in Fog. 4G) or at any other suitable position in wheel assembly 301. Transmission assembly 370 may, for example, include gears 371 (e.g., as shown in FIG. 3G), belts, chains or any other suitable transmission components or combinations thereof. Transmission assembly 370 may couple hub shaft 330 to a motor 372 (e.g., as schematically indicated in FIGS. 3F and 3G).

In some cases, for example as shown in FIGS. 3F-3G, when upright 310 is coupled to suspension arm 360, suspension arm 360 and/or other components of a vehicle and/or of a wheel corner assembly may prevent an access to cavity 314 of upright 310 through inner end 312 of upright 310. Wheel hub assembly 300 (as well as wheel hub assemblies 100 and 200 described hereinabove) allow insertion and assembly of components of wheel hub assembly 300 within cavity 314 of upright 310 through opening 315 on outer end 311 of upright 310 without a need in accessing upright 310 from its inner end 312. This may be advantageous over prior art wheel hub assemblies (e.g., as described hereinabove).

It is noted that suspension arm 360 of wheel assembly 301 may be any one of trailing arm, leading arm, control arm (e.g., control arm of a double or single wish bone suspension assembly) or any other suitable suspension arm.

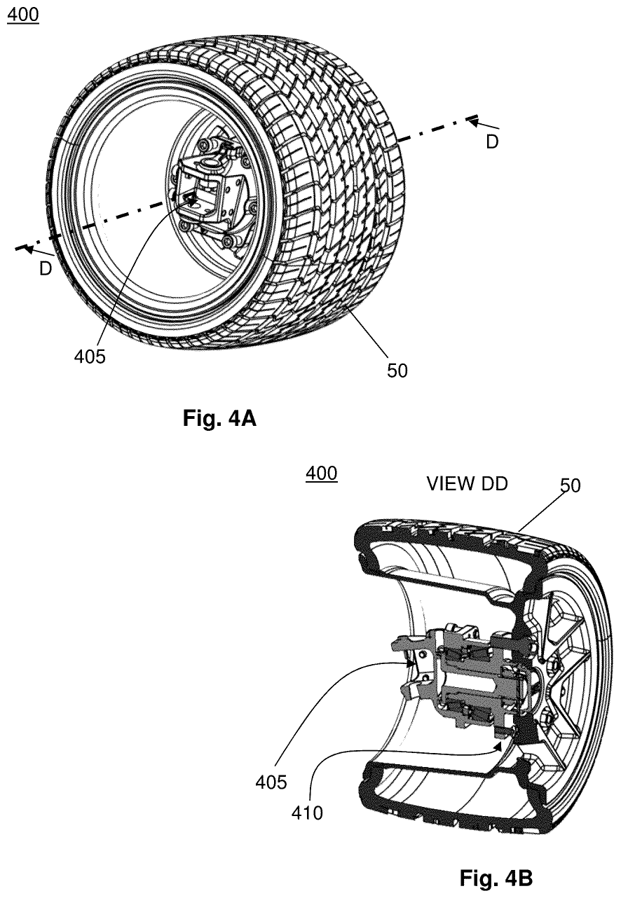

Reference is made to FIG. 4A, which is a 3D diagram of a wheel assembly 400 and a wheel 50 coupled to wheel assembly 400, according to some embodiments of the invention.

Reference is also made to FIG. 4B, which is a partial sectional view of wheel assembly 400 and wheel 50 along line DD of FIG. 4A, according to some embodiments of the invention.

Wheel assembly 400 may include an upright 405 and a wheel hub assembly 410. Upright 405 may be any one of uprights 110, 210 or 310 described hereinabove and/or wheel hub assembly 410 may be any one of wheel hub assemblies 100, 200 or 300 described hereinabove. In the example of FIGS. 4A and 4B, upright 405 is similar to upright 110 described hereinabove and wheel hub assembly 410 is similar to wheel hub assembly 100 described hereinabove. Wheel assembly 400 may include a wheel 50 coupled to a hub (e.g., such as hub 120, 220 or 320 disclosed herein) of wheel hub assembly 410.

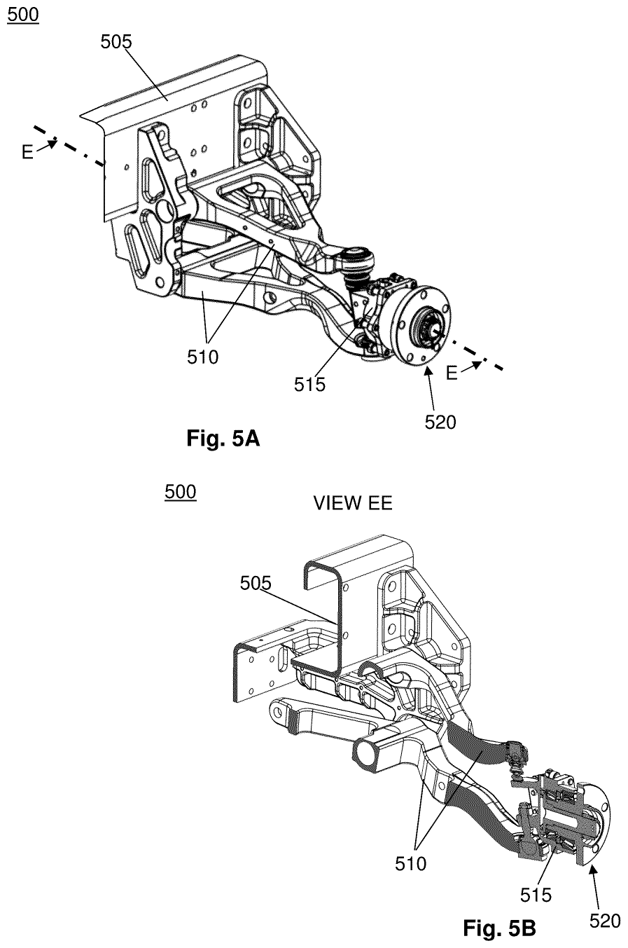

Reference is made to FIG. 5A, which is a 3D diagram of a wheel corner assembly 500, according to some embodiments of the invention.

Reference is also made to FIG. 5B, which is a partial sectional view of wheel corner assembly 500 along line EE of FIG. 5A, according to some embodiments of the invention.

Wheel corner assembly 500 may include one or more suspension arms 510 rotatably coupled to a reference frame 505 of a vehicle (e.g. chassis, body) or a sub-frame 505 that couples wheel corner assembly 500 to the reference frame of the vehicle. Suspension arms 510 may be transverse to reference frame or sub-frame 505, e.g. one or more control arms. Wheel corner assembly 500 may include an upright 515. Upright 515 may be coupled (e.g., at its inner end) to suspension arms 510. Upright 515 may be any one of uprights 110, 210 or 310 described hereinabove. Wheel corner assembly 500 may include a wheel hub assembly 520. Wheel hub assembly 520 may be any one of wheel hub assemblies 100, 200 or 300 described hereinabove. In the example of FIGS. 5A and 5B, wheel hub assembly 520 is similar to wheel hub assembly 100 described hereinabove.

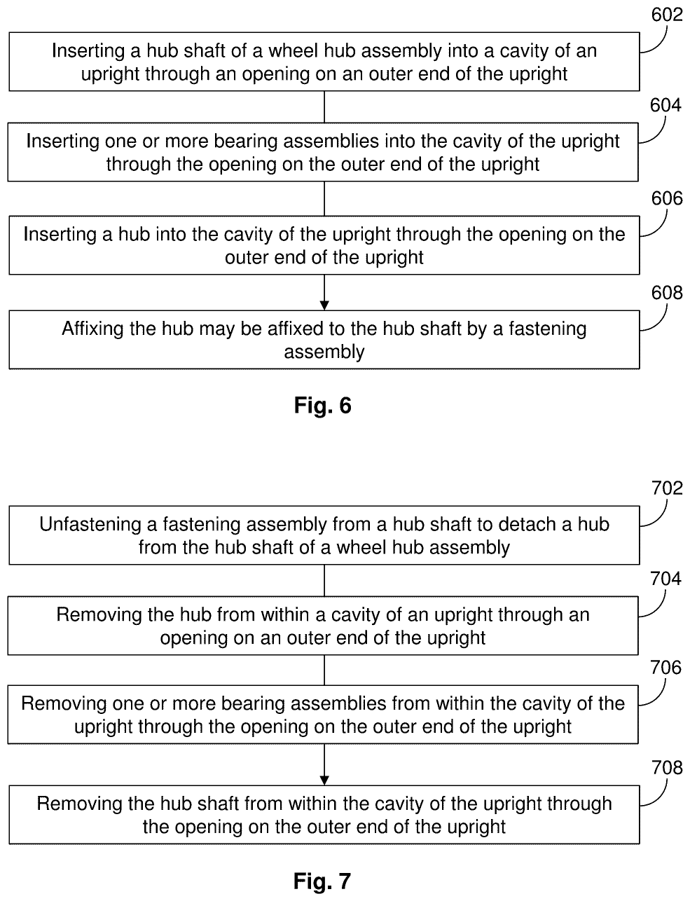

Reference is made to FIG. 6, which is a flowchart of a method of assembling a wheel hub assembly (e.g., such as wheel hub assembly 100 or wheel hub assembly 200 described hereinabove) to an upright of a wheel assembly, according to some embodiments of the invention.

In operation 602, a bolt (e.g., hub shaft 130 or hub shaft 230) of a wheel hub assembly (e.g., wheel hub assembly 100 or wheel hub assembly 200) may be inserted into a cavity (e.g., hub cavity) of the upright through an opening (e.g., cavity opening) on an outer end of the upright (e.g., as in operation 100a of FIG. 1G or in operation 200a of FIG. 2D). The hub shaft may extend along a rotation axis. The upright may be coupled to a suspension at its inner end that is opposed to the outer end (e.g., as described hereabove). In some embodiments, the hub shaft may be coupled (e.g., directly or via a transmission) to a motor (e.g., such as hub shaft 430 as described hereinabove).

In operation 604, one or more bearing assemblies may be inserted into the cavity of the upright through the opening on the outer end of the upright.

For example, a first bearing assembly (e.g., first bearing assembly 140) may be inserted into the cavity of the upright through the opening on the outer end of the upright (e.g., as in operation 100c of FIG. 1G). A nut (e.g., nut 144) may be then inserted into the cavity of the upright through the opening on the outer end of the upright and screwed into the cavity of the upright to hold the first bearing assembly and the hub shaft within the cavity of the upright (e.g., as in operation 100c of FIG. 1G). A retaining ring (e.g., retaining ring 146) may be then inserted into the cavity of the upright through the opening on the outer end of the upright and engaged with the upright and the nut to prevent the nut from unintentionally unscrewing from within the cavity of the upright (e.g., as in operation 100g of FIG. 1G). A second bearing assembly (e.g., second bearing assembly 142) may be then inserted into the cavity of the upright through the opening on the outer end of the upright (e.g., as in operation 100i of FIG. 1G).

In another example, one bearing assembly (e.g., bearing assembly 240) may be inserted into the cavity of the upright through the opening on the outer end of the upright (e.g., as in operation 200c of FIG. 2D). A nut (e.g., nut 244) may be then inserted into the cavity of the upright through the opening on the outer end of the upright and screwed into the cavity of the upright to hold the first bearing assembly and the hub shaft within the cavity of the upright (e.g., as in operation 200e of FIG. 2D). A retaining ring (e.g., retaining ring 246) may be then engaged with the upright and the nut to prevent the nut from unintentionally unscrewing from within the cavity of the upright (e.g., as in operation 200g of FIG. 2D).

In operation 606, a hub (e.g., hub 120 or hub 220) may be inserted into the cavity of the upright through the opening on the outer end of the upright (e.g., as in operation 100k of FIG. 1G or in operation 200i of FIG. 2D). An axial bore of the hub may be slid onto the hub shaft to dispose a portion of the hub between the hub shaft and the one or more bearing assemblies.

In operation 608, the hub may be affixed (e.g., fastened) to the hub shaft by a fastening assembly (e.g., fastening assembly 150 or fastening assembly 250; as in operation 100m of FIG. 1G or operation 200k of FIG. 2D). The hub may be affixed to the hub shaft by applying an axial force by the fastening assembly.

In some embodiments, the one or more bearing assemblies (e.g., first bearing assembly 140 and second bearing assembly 142) may be preloaded in the axial direction by the fastening assembly (e.g., by tightening a castle nut (e.g., castle nut 152) of the fastening assembly, as described above with respect to FIGS. 1A-1G).

In some embodiments, the one or more bearing assemblies (e.g., one bearing assembly 240) may be preloaded prior to inserting the one or more bearing assemblies into the cavity of the upright.

Reference is made to FIG. 7, which is a flowchart of a method of disassembling a wheel hub assembly (e.g., such as wheel hub assembly 100 described hereinabove) from an upright of a wheel assembly, according to some embodiments of the invention.

In operation 702, a fastening assembly (e.g., fastening assembly 150 or fastening assembly 250) may be unfastened from a hub shaft (e.g., hub shaft 130 or hub shaft 230) to detach a hub (e.g., hub 120 or hub 220) from the hub shaft of a wheel hub assembly (e.g., wheel hub assembly 100 or wheel hub assembly 200).

In operation 704, the hub may be removed from within a cavity of an upright through an opening on an outer end of the upright. The upright may be coupled to a suspension at its inner end that is opposed to the outer end thereof (e.g., as described hereabove).

In operation 706, one or more bearing assemblies may be removed from within the cavity of the upright through the opening on the outer end of the upright.

For example, an outer bearing assembly (e.g., second bearing assembly 142) may be removed from within the cavity of the upright through the opening on the outer end of the upright. A retaining ring (e.g., retaining ring 146) may be then removed from within the cavity of the upright through the opening on the outer end of the upright to allow a nut (e.g., nut 144) to be unscrewed from within the cavity of the upright. The nut may be unscrewed and removed from within the cavity of the upright through the opening on the outer end of the upright. An inner bearing assembly (e.g., first bearing assembly 140) may be then removed from within the cavity of the upright through the opening on the outer end of the upright.

In another example, a retaining ring (e.g., retaining ring 246) may be removed from the upright to allow a nut (e.g., nut 244) to be unscrewed from within the cavity of the upright. The nut may be unscrewed and removed from within the cavity of the upright through the opening on the outer end of the upright. The bearing assembly (e.g., bearing assembly 240) may be then removed from within the cavity of the upright through the opening on the outer end of the upright.

In operation 708, the hub shaft may be removed from within the cavity of the upright through the opening on the outer end of the upright. In some embodiments, the hub shaft may be decoupled from the motor (e.g., as described hereinabove).

The wheel hub assembly may be reassembled to the upright as described hereinabove. If required, at least one of the one or more bearing assemblies may be replaced with the respective at least one new bearing assembly when the wheel hub assembly is reassembled to the upright.

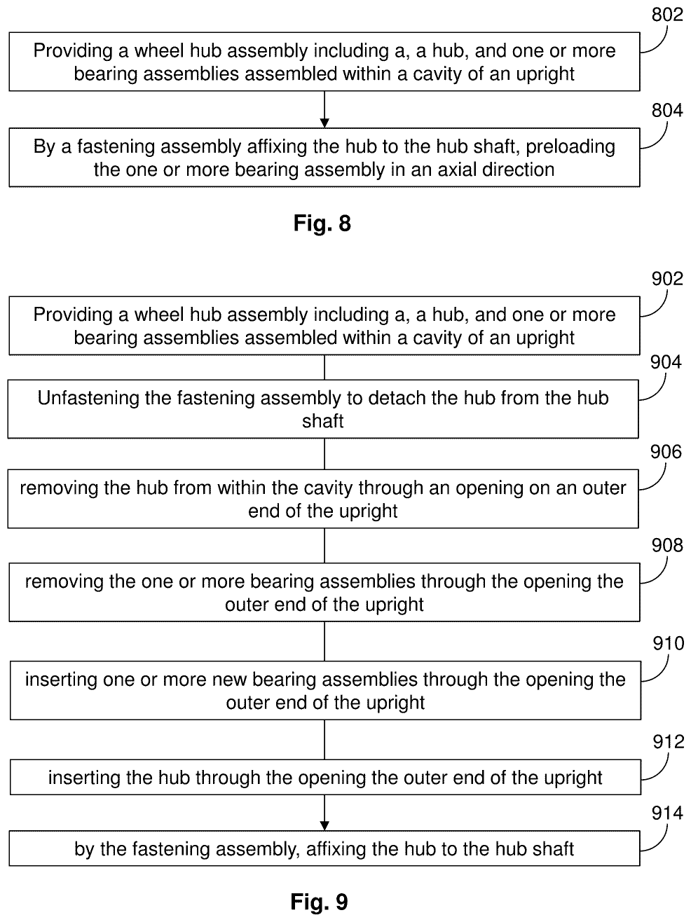

Reference is made to FIG. 8, which is a flowchart of a method of preloading one or more bearing assemblies of a wheel hub assembly (e.g., such as wheel hub assembly 100 described hereinabove), according to some embodiments of the invention.

In operation 802, a wheel hub assembly (e.g., wheel hub assembly 100) including a hub shaft (e.g., hub shaft 130), a hub (e.g., hub 120), and one or more bearing assemblies (e.g., bearing assemblies 140, 142) assembled within a cavity of an upright may be provided. The upright may be coupled to a suspension at its inner end that is opposed to the outer end thereof (e.g., as described hereabove).

In operation 804, the one or more bearing assemblies may be preloaded in an axial direction by a fastening assembly (e.g., fastening assembly 150) affixing the hub to the hub shaft. For example, the one or more bearing assemblies may be preloaded in the axial direction by tightening a castle nut of the fastening assembly (e.g., as described hereinabove).

Reference is made to FIG. 9, which is a flowchart of a method of replacing of one or more bearing assemblies of a wheel hub assembly, according to some embodiments of the invention.

In operation 902, a wheel hub assembly (e.g., wheel hub assembly 100 or wheel hub assembly 200) including a hub shaft (e.g., hub shaft 130 or hub shaft 230), a hub (e.g., hub 120 or hub 220), and one or more bearing assemblies (e.g., bearing assemblies 140, 142 or bearing assembly 240) assembled within a cavity of an upright and a fastening assembly affixing the hub to the hub shaft may be provided. The upright may be coupled to a suspension at its inner end that is opposed to the outer end thereof (e.g., as described hereabove).

In operation 904, the fastening assembly may be unfastened to detach the hub from the hub shaft.

In operation 906, the hub may be removed from within the cavity of the upright through an opening on an outer end of the upright.

In operation 908, the one or more bearing assemblies may be removed from within the cavity of the upright through the opening on the outer end of the upright (e.g., as described hereabove).

In operation 910, one or more new bearing assemblies may be inserted into the cavity of the upright through the opening on the outer end of the upright (e.g., as described hereabove).

In operation 912, the hub may be inserted into the cavity of the upright through the opening on the outer end of the upright (e.g., as described hereabove).

In operation 914, the hub may be affixed to the hub shaft by the fastening assembly (e.g., as described hereinabove).

In some embodiments, the one or more new bearing assemblies may be preloaded in an axial direction by the fastening assembly (e.g., as described hereinabove). For example, the one or more new bearing assemblies may be preloaded by tightening a castle nut of the fastening assembly (e.g., as described hereinabove).

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A wheel hub assembly couplable to an upright comprising an axial hub cavity having a cavity opening at an outer end of the upright, the wheel hub assembly comprising:
a hub extending axially along a rotation axis, the hub comprising a bore extending axially along the rotation axis;
a hub shaft extending through the bore of the hub;
one or more bearing assemblies, each bearing assembly comprising an annular housing surrounding at least a portion of the hub; and
a fastening assembly to affix the hub and the hub shaft together;
wherein the hub shaft, the hub and the one or more bearing assemblies are removably insertable into the hub cavity and assemblable within the hub cavity through the cavity opening.

2. The wheel hub assembly of claim 1, wherein the hub shaft, the hub and the one or more bearing assemblies are removably insertable into the hub cavity, assemblable, and affixed within the hub cavity through the cavity opening.

3. The wheel hub assembly of claim 1, wherein the one or more bearings assemblies is preloaded in an axial direction by the fastening assembly.

4. The wheel hub assembly of claim 1, wherein the one or more bearing assemblies comprises: a first bearing assembly and a second bearing assembly, the first bearing assembly being disposed within the hub cavity deeper than the second bearing assembly relative to the cavity opening.

5. The wheel hub assembly of claim 4, comprising a nut removably insertable into the hub cavity through the cavity opening, the nut being screwed into the hub cavity to hold the first bearing assembly and the hub shaft within the hub cavity.

6. The wheel hub assembly of claim 4, wherein the fastening assembly comprises a castle nut screwable onto the hub shaft to affix the hub to the hub shaft and to preload the first bearing assembly and the second bearing assembly in the axial direction.

7. The wheel hub assembly of claim 5, wherein the nut applies, on an outer ring of the annular housing of the first bearing assembly, an axial force in a first axial direction, and the hub shaft applies, on an inner ring of the annular housing of the first bearing assembly an axial force in a second axial direction that is opposed to the first axial direction thereby preloading the first bearing assembly in an axial direction.

8. The wheel hub assembly of claim 5, wherein the hub applies, on an inner ring of the annular housing of the second bearing assembly, an axial force in a first axial direction, and the nut applies, on an outer ring of the annular housing of the second bearing assembly, an axial force in a second axial direction that is opposed to the first axial direction thereby preloading the second bearing assembly in an axial direction.

9. The wheel hub assembly of claim 4, wherein the first bearing assembly and the second bearing assembly are tapered rolling bearings.

10. The wheel hub assembly of claim 4, wherein the first bearing assembly and the second bearing assembly are tapered in opposite directions.

11. The wheel hub assembly of claim 1, wherein the one or more bearing assemblies comprises one bearing assembly.

12. A wheel assembly comprising:
an upright comprising: a cavity, an outer end comprising an opening providing an access to the cavity, and an inner end that is opposed to the outer end; and
a wheel hub assembly comprising:
a hub extending from within the cavity of the upright external thereto, the hub comprising a bore extending through a length of the hub;
a hub shaft extending through the bore of the hub from within the cavity of the upright external thereto;
one or more bearing assemblies, each bearing assembly comprising an annular housing surrounding at least a part of a longitudinal portion of the hub; and
a fastening assembly to affix the hub and the hub shaft together;
wherein the hub shaft, the hub and the one or more bearing assemblies are removably insertable into the cavity and assemblable within the cavity of the upright through the opening on the outer end of the upright.

13. The wheel assembly of claim 12, wherein the hub shaft, the hub and the one or more bearing assemblies are removably insertable into the cavity and assemblable within the cavity of the upright only through the opening on the outer end of the upright.

14. The wheel assembly of claim 12, wherein the upright is configured to prevent an access to the cavity of the upright through the inner end of the upright.

15. The wheel assembly of claim 12, wherein the inner end of the upright is a closed end.

16. The wheel assembly of claim 12, wherein the upright comprises a suspension coupler to couple the upright to a suspension, and wherein the suspension coupler and the opening of the cavity of the upright are disposed at opposing ends of the upright with respect to each other.

17. The wheel assembly of claim 12, wherein the one or more bearing assemblies is preloaded in an axial direction by the fastening assembly.

18. The wheel assembly of claim 12, wherein the one or more bearing assemblies comprises: a first bearing assembly and a second bearing assembly, the first bearing assembly being disposed within the cavity of the upright deeper than the second bearing assembly relative to the opening on the outer end of the upright.

19. The wheel assembly of claim 12, wherein the wheel hub assembly comprises a nut removably insertable into the cavity through the opening on the outer end of the upright, the nut being screwed into the cavity to hold the first bearing assembly and the hub shaft within the cavity.

20. The wheel assembly of claim 12, wherein the fastening assembly comprises a castle nut screwable onto the hub shaft to affix the hub to the hub shaft and to preload the first bearing assembly and the second bearing assembly in an axial direction.

21. The wheel assembly of claim 19, wherein the nut applies, on an outer ring of the annular housing of the first bearing assembly, an axial force in a first axial direction, and the hub shaft applies, on an inner ring of the annular housing of the first bearing assembly an axial force in a second axial direction that is opposed to the first axial direction thereby preloading the first bearing assembly in the axial direction.

22. The wheel assembly of claim 19, wherein the hub applies, on an inner ring of the annular housing of the second bearing assembly, an axial force in a first axial direction, and the nut applies, on an outer ring of the annular housing of the second bearing assembly, an axial force in a second axial direction that is opposed to the first axial direction thereby preloading the second bearing assembly in the axial direction.

23. The wheel assembly of claim 12, wherein the first bearing assembly and the second bearing assembly are tapered rolling bearings.

24. The wheel assembly of claim 12, wherein the first bearing assembly and the second bearing assembly are tapered in opposite directions.
